(19) United States
(12) Patent Application Publication
(10) Pub. No.: US 2012/0314957 A1
(43) Pub. Date: Dec. 13, 2012

(54) INFORMATION PROCESSING APPARATUS, INFORMATION PROCESSING METHOD, AND PROGRAM

(75) Inventor: Natsuko Narikawa, Tokyo (JP)

(73) Assignee: SONY CORPORATION, Tokyo (JP)

(21) Appl. No.: 13/488,683

(22) Filed: Jun. 5, 2012

(30) Foreign Application Priority Data
Jun. 13, 2011 (JP) 2011-131295

(51) Int. Cl. G06K 9/46; G06K 9/68

(52) U.S. Cl. 382/195; 382/227

(57) ABSTRACT

There is provided an information processing apparatus including a multi-stage determining unit that includes determinators which each function as a node of an N-level tree structure (N is an integer value of 2 or more) in order to perform determination for classifying a determination target into at least one of a plurality of ranges. Each determinator performs determination of classifying the determination target into any one of two ranges, and the two ranges determined in each determinator include an overlapping portion. The present technology can be applied to an information processing apparatus that classifies data.

### CROSS-REFERENCE TO RELATED APPLICATION

The present application claims priority from Japanese Patent Application No. JP 2011-131295 filed in the Japanese Patent Office on Jun. 13, 2011, the entire content of which is incorporated herein by reference.

### BACKGROUND

The present technology relates to an information processing apparatus, an information processing method, and a program, and more particularly, to an information processing apparatus, an information processing method, and a program, which are capable of suppressing erroneous classification when data is classified into any one of a plurality of ranges.

In the past, a technique of classifying data of a classification target into any one of a plurality of ranges which are divided in advance has been known as a data classifying technique. As an example in which the classifying technique is concretely applied, Japanese Patent Application Laid-Open (JP-A) No. 2009-271885 discloses a technique of classifying a person's face into any one of a plurality of age ranges (20's, 30's, 40's, and the like) based on a feature quantity of the person's face included in an image.

### SUMMARY

However, in techniques of the related arts including the technique disclosed in JP-A No. 2009-271885, when data close to an upper limit or a lower limit of a predetermined range is set as a classification target, the data is erroneously classified into a different range before or after the predetermined range in many cases. For example, in the case of the technique disclosed in JP-A No. 2009-271885, when a face of a person having an age close to an upper limit (e.g., 29 which is an upper limit of 20's) of a predetermined age range is set as a classification target, the person's face is sometimes erroneously classified into an age range (e.g., 30's) which is one rank higher than the predetermined age range.

The present technology is made in light of the foregoing, and it is desirable to be able to suppress erroneous classification when data is classified into any one of a plurality of ranges.

According to an embodiment of the present technology, there is provided an information processing apparatus including a multi-stage determining unit that includes determinators which each function as a node of an N-level tree structure (N is an integer value of 2 or more) in order to perform determination for classifying a determination target into at least one of a plurality of ranges, wherein each determinator performs determination of classifying the determination target into any one of two ranges, and the two ranges determined in each determinator include an overlapping portion.

A predetermined range from a boundary between the two ranges may be set as a dead zone range in advance, and when a determinator of a predetermined level has classified the determination target into the dead zone range, the multi-stage determining unit may prohibit determination of a determinator of a next level and perform final determination based on a determination result of up to the determinator of the predetermined level.

The multi-stage determining unit may further include a feature quantity extracting unit that extracts a feature quantity related to the determination target from an image including the determination target, and each determinator may perform the determination based on the feature quantity extracted by the feature quantity extracting unit.

The multi-stage determining unit may set each of a plurality of unit images configuring a moving image as a processing target, and for each processing target, the feature quantity extracting unit may extract a feature quantity, and each determinator may perform the determination, and the information processing apparatus may further include a result integrating unit that integrates a result of the determination for each processing target by the multi-stage determining unit.

The processing target may include a plurality of processing targets, the multi-stage determining unit may further include a feature quantity extracting unit that extracts a feature quantity related to the processing target for each of the plurality of processing targets, and the information processing apparatus may further include a result integrating unit that integrates a result of the determination for each of the plurality of processing targets by the multi-stage determining unit.

The result integrating unit may set a reliability distribution in each range represented by each result of the determination for each processing target by the multi-stage determining unit and calculate a probability distribution that the determination target is classified into a predetermined range by adding the reliability distribution of each processing target.

The determination target may be a person, the plurality of ranges related to an age may be set in advance, the feature quantity extracting unit may extract a feature quantity of a face from an image including a person's face, and each determinator may determine an age range of the person having the face and classify the person's age into any one of the plurality of ranges.

The determination target may be a person, the plurality of ranges related to a race may be set in advance, the feature quantity extracting unit may extract a feature quantity of a face from an image including a person's face, and each determinator may determine a race range of the person having the face and classify the person's race into any one of the plurality of ranges.

The determination target may be a person, the plurality of ranges related to a facial expression may be set in advance, the feature quantity extracting unit may extract a feature quantity of a face from an image including a person's face, and each determinator may determine a facial expression range of the person having the face and classify the person's facial expression into any one of the plurality of ranges.

The feature quantity extracting unit may extract a feature quantity related to a person's clothes from the image.

An information processing method and program according to an embodiment of the present technology are a method and program corresponding to the information processing apparatus according to the embodiment of the present technology.

According to another embodiment of the present technology, there are provided an information processing method and program including preparing determinators which each function as a node of an N-level tree structure (N is an integer value of 2 or more) in order to perform determination for classifying a determination target into at least one of a plurality of ranges, and performing, with each determinator, determination of classifying the determination target into any one of two ranges, wherein the two ranges determined in each determinator include an overlapping portion.

According to the embodiments of the present technology, erroneous classification can be suppressed when data is classified into any one of a plurality of ranges.

### BRIEF DESCRIPTION OF THE DRAWINGS

FIG. 1 is a block diagram illustrating a configuration of an age estimating apparatus;

FIG. 2 is a diagram illustrating a detailed configuration example of an age estimating unit;

FIG. 3 is a flowchart for explaining the flow of an age estimation process;

FIG. 4 is a flowchart for explaining the flow of a multi-stage determination process;

FIG. 5 is a diagram for explaining a process of a learning unit;

FIG. 6 is a diagram illustrating a detailed configuration example of an age estimating unit;

FIG. 7 is a diagram for explaining a process of a learning unit;

FIG. 8 is a diagram illustrating a configuration example of a multi-stage determining unit and an estimation result holding unit;

FIG. 9 is a block diagram illustrating a configuration of an age estimating apparatus;

FIG. 10 is a diagram for explaining a tracking operation;

FIG. 11 is a flowchart to explain the flow of an age estimation process;

FIG. 12 is a diagram for explaining estimation result integration;

FIG. 13 is a diagram illustrating a configuration example of a multi-stage determining unit using race as a determination target;

FIG. 14 is a diagram illustrating a configuration example of a multi-stage determining unit using a facial expression as a determination target;

FIG. 15 is a diagram illustrating a configuration example of a multi-stage determining unit in which a book is set as a determination target of classification and a genre of a book is set as a category of classification;

FIG. 16 is a diagram for explaining a multi-stage determining unit configured to include determinators for determining determination targets of each of different types;

FIG. 17 is a diagram for explaining another example of estimation result integration;

FIG. 18 is a diagram illustrating paths of determinators used by a multi-stage determining unit;

FIG. 19 is a diagram for explaining another example of estimation result integration;

FIG. 20 is a diagram illustrating another configuration example of a multi-stage determining unit;

FIG. 21 is a diagram illustrating another configuration example of a multi-stage determining unit;

FIG. 22 is a block diagram illustrating another configuration example of an age estimating apparatus;

FIG. 23 is a block diagram illustrating another configuration example of an age estimating apparatus; and

FIG. 24 is a block diagram illustrating a hardware configuration example of an information processing apparatus to which the present technology is applied.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

As embodiments of the present technology, four embodiments (which are hereinafter referred to as first to fourth embodiments) will be described in the following order:

1. First Embodiment (Example of Age Estimation in Still Image by Determinators Configuring Tree Structure)

2. Second Embodiment (Example of Age Estimation by Determinators with Margin Configuring Tree Structure)

3. Third Embodiment (Example of Age Estimation by Determinators with Intermediate End Configuring Tree Structure)

4. Fourth Embodiment (Example Using Estimation Result by Determinators Configuring Tree Structure for Other Estimation)

Hereinafter, embodiments of the present technology will be described with reference to the accompanying drawings.

### 1. First Embodiment

### [Configuration Example of Age Estimating Apparatus 1]

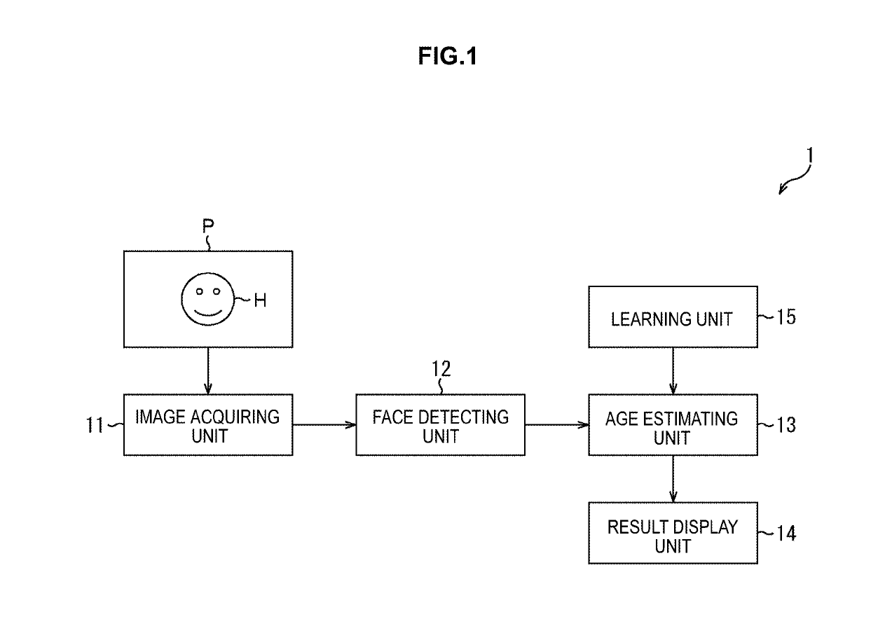

FIG. 1 is a block diagram illustrating a configuration of an age estimating apparatus 1.

The age estimating apparatus 1 includes an image acquiring unit 11, a face detecting unit 12, an age estimating unit 13, a result display unit 14, and a learning unit 15.

The image acquiring unit 11 is a device capable of acquiring an image, such as a still camera or a web camera, and acquires an image P which is a still image including a facial image H of a subject. The image acquiring unit 11 may acquire the image P including the facial image H of the subject from picture data or video data which is stored in advance.

The face detecting unit 12 detects the facial image H included in the image P from the whole area of the image P acquired by the image acquiring unit 11. A technique of detecting the facial image H is not particularly limited, and for example, the facial image H may be detected by detecting an arrangement of coloration areas of parts configuring a face such as eyes, a nose, a mouth, and ears from the image P acquired by the image acquiring unit 11.

The age estimating unit 13 extracts a feature quantity of a face from the facial image H detected by the face detecting unit 12 and estimates an age of a person having a corresponding face based on the feature quantity of the face.

The result display unit 14 displays an age estimation result obtained by the age estimating unit 13 on a display device or the like. The age estimation result obtained by the age estimating unit 13 may be not only displayed through the result display unit 14 but also stored in a storage unit (not shown).

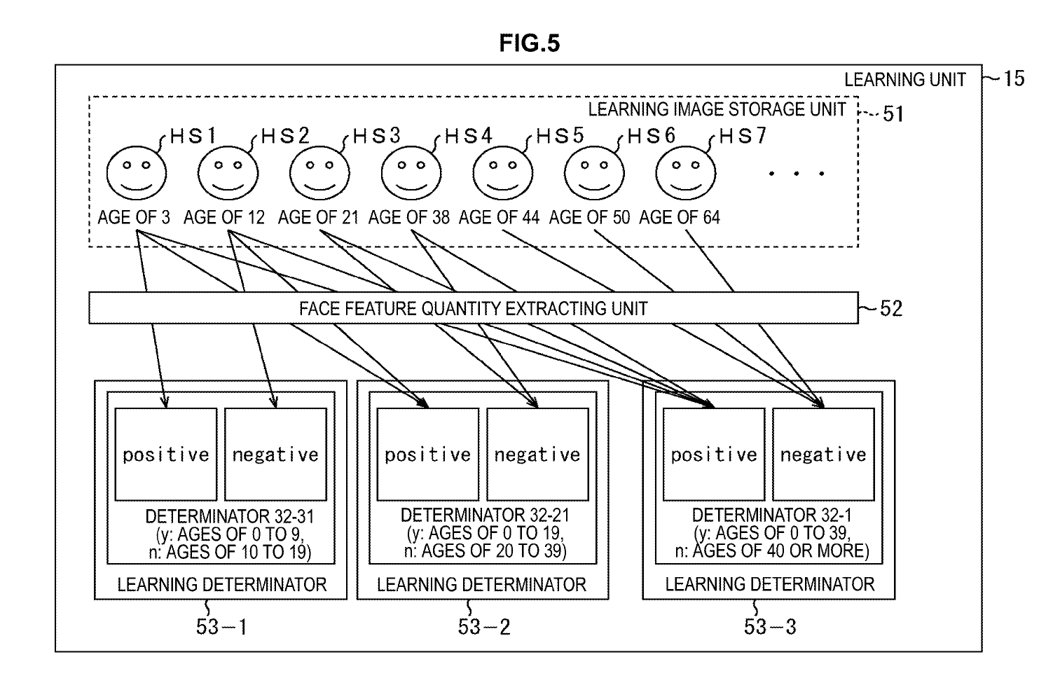

The learning unit 15 can cause each determinator, included in the age estimating unit 13 which will be described later, to perform learning, and cause each determinator to determine which one of a plurality of previously set age ranges a feature quantity of a face is classified into. The details of the learning unit 15 will be described later with reference to FIG. 5.

### [Configuration Example of Age Estimating Unit 13]

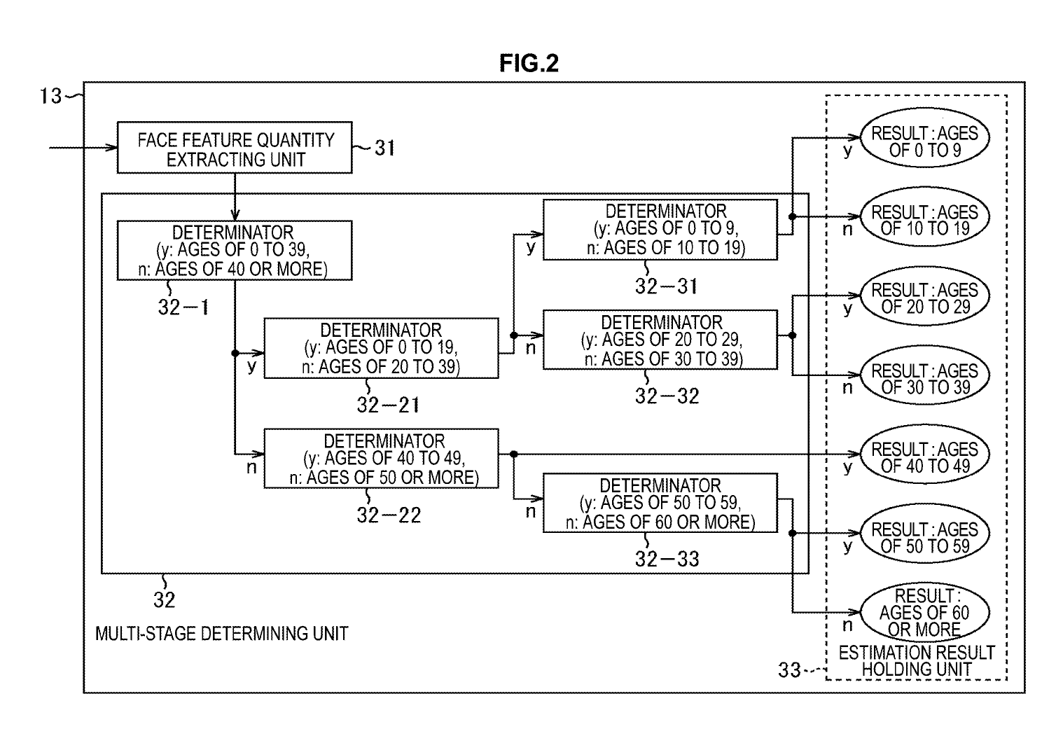

FIG. 2 is a diagram illustrating a detailed configuration example of the age estimating unit 13.

The age estimating unit 13 includes a face feature quantity extracting unit 31, a multi-stage determining unit 32, and an estimation result holding unit 33.

The face feature quantity extracting unit 31 extracts a feature quantity of a face from the facial image H detected by the face detecting unit 12. The feature quantity is not particularly limited as long as the feature quantity can be used for recognition of an object. For example, brightness information, edge information, a Haar feature quantity, or the like may be used as the feature quantity.

The multi-stage determining unit 32 determines which one of a plurality of previously set age ranges an age of a person having a corresponding face is classified into based on the feature quantity of the face extracted by the face feature quantity extracting unit 31. The multi-stage determining unit 32 includes a determinator 32-1, determinators 32-21 and 32-22, and determinators 32-31 to 32-33.

When the determinator 32-1 is arranged as a first-stage node, the determinators 32-21 and 32-22 are arranged as second-stage nodes which are one stage lower than the determinator 32-1. Further, the determinators 32-31 and 32-32 are arranged as third-stage nodes which are one stage lower than the determinator 32-21. The determinator 32-33 is arranged as a third-stage node which is one stage lower than the determinator 32-22. As described above, in the present embodiment, the multi-stage determining unit 32 is configured with nodes of a three-level tree structure such as the determinators 32-1, 32-21, 32-22, and 32-31 to 32-33.

In the following, when it is unnecessary to distinguish the determinators 32-1, 32-21, 32-22, and 32-31 to 32-33 from one another, that is, when it is unnecessary to particularly focus on a difference in a hierarchical relationship, the determinators 32-1, 32-21, 32-22, and 32-31 to 32-33 are collectively referred to as a “determinator 32.”

Each determinator 32 solves a 2-class determination problem. In other words, in the present embodiment, two different age ranges are assigned to each determinator 32 as two classes. Thus, each determinator 32 determines which of two age ranges an age of a person having a corresponding face is classified into based on the input feature quantity of the face. That is, each determinator 32 determines which of two classes an age of a person having a corresponding face is classified into based on the input feature quantity of the face.

Specifically, a first age range “ages of 0 to 39” and a second age range “ages of 40 or more” are assigned to the first-stage determinator 32-1 as 2 classes represented as “y: ages of 0 to 39, n: ages of 40 or more” in FIG. 2. Thus, the first-stage determinator 32-1 determines which of the first and second age ranges an age of a person having a corresponding face is classified into based on the feature quantity of the face extracted by the face feature quantity extracting unit 31.

Thus, in FIG. 2, “y” represents that classification into the first age range is made, and “n” represents that classification into the second age range is made.

When the first-stage determinator 32-1 classifies the age of the person having the corresponding face into the first age range “ages of 0 to 39” based on the feature quantity of the face extracted by the face feature quantity extracting unit 31, the feature quantity of the face is supplied to the second-stage determinator 32-21 together with the classification result. However, when the first-stage determinator 32-1 classifies the age of the person having the corresponding face into the second age range “ages of 40 or more” based on the feature quantity of the face extracted by the face feature quantity extracting unit 31, the feature quantity of the face is supplied to the second-stage determinator 32-22 together with the classification result.

A first age range “ages of 0 to 19” and a second age range “ages of 20 to 39” are assigned to the second-stage determinator 32-21 as two classes represented as “y: ages of 0 to 19, n: ages of 20 to 39” in FIG. 2. Thus, the second-stage determinator 32-21 determines which of the first and second age ranges an age of a person having a corresponding face is classified into based on the feature quantity of the face input by the first-stage determinator 32-1.

When the second-stage determinator 32-21 classifies the age of the person having the corresponding face into the first age range “ages of 0 to 19” based on the feature quantity of the face input by the first-stage determinator 32-1, the feature quantity of the face is supplied to the third-stage determinator 32-31 together with the classification result. However, the second-stage determinator 32-21 classifies the age of the person having the corresponding face into the second age range “ages of 20 to 39” based on the feature quantity of the face input by the first-stage determinator 32-1, the feature quantity of the face is supplied to the third-stage determinator 32-32 together with the classification result.

A first age range “ages of 40 to 49” and a second age range “ages of 50 or more” are assigned to the second-stage determinator 32-22 as two classes represented as “y: ages of 40 to 49, n: ages of 50 or more” in FIG. 2. Thus, the second-stage determinator 32-22 determines which of the first and second age ranges the age of the person having the corresponding face is classified into based on the feature quantity of the face input by the first-stage determinator 32-1.

When the second-stage determinator 32-22 classifies the age of the person having the corresponding face into the first age range “ages of 40 to 49” based on the feature quantity of the face input by the first-stage determinator 32-1, “ages of 40 to 49,” which is the classification result, is supplied to the estimation result holding unit 33. However, when the second-stage determinator 32-22 classifies the age of the person having the corresponding face into the second age range “ages of 50 or more” based on the feature quantity of the face input by the first-stage determinator 32-1, the feature quantity of the face is supplied to the third-stage determinator 32-33 together with the classification result.

A first age range “ages of 0 to 9” and a second age range “ages of 10 to 19” are assigned to the third-stage determinator 32-31 as two classes represented as “y: ages of 0 to 9, n: ages of 10 to 19” in FIG. 2. Thus, the third-stage determinator 32-31 determines which of the first and second age ranges the age of the person having the corresponding face is classified into based on the feature quantity of the face input by the second-stage determinator 32-21.

When the third-stage determinator 32-31 classifies the age of the person having the corresponding face into the first age range “ages of 0 to 9” based on the feature quantity of the face input by the second-stage determinator 32-21, “ages of 0 to 9,” which is the classification result, is supplied to the estimation result holding unit 33. However, when the third-stage determinator 32-31 classifies the age of the person having the corresponding face into the first age range “ages of 10 to 19” based on the feature quantity of the face input by the second-stage determinator 32-21, “ages of 10 to 19,” which is the classification result, is supplied to the estimation result holding unit 33.

A first age range “ages of 20 to 29” and a second age range “ages of 30 to 39” are assigned to the third-stage determinator 32-32 as two classes represented as “y: ages of 20 to 29, n: ages of 30 to 39” in FIG. 2. Thus, when the third-stage determinator 32-32 determines which of the first and second age ranges the age of the person having the corresponding face is classified into based on the feature quantity of the face input by the second-stage determinator 32-21.

When the third-stage determinator 32-32 classifies the age of the person having the corresponding face into the first age range “ages of 20 to 29” based on the feature quantity of the face input by the second-stage determinator 32-21, “ages of 20 to 29” which is the classification result is supplied to the estimation result holding unit 33. However, when the third-stage determinator 32-31 classifies the age of the person having the corresponding face into the second age range “ages of 30 to 39” based on the feature quantity of the face input by the second-stage determinator 32-21, “ages of 30-39,” which is the classification result, is supplied to the estimation result holding unit 33.

A first age range “ages of 50 to 59” and a second age range “ages of 60 or more” are assigned to the third-stage determinator 32-33 as two classes represented as “y: ages of 50 to 59, n: ages of 60 or more” in FIG. 2. Thus, the third-stage determinator 32-33 determines which of the first and second age ranges an age of a person having a corresponding face is classified into based on the feature quantity of the face input by the second-stage determinator 32-22.

When the third-stage determinator 32-33 classifies the age of the person having the corresponding face into the first age range “ages of 50 to 59” based on the feature quantity of the face input by the second-stage determinator 32-22, “ages of 50 to 59,” which is the classification result, is supplied to the estimation result holding unit 33. However, when the third-stage determinator 32-33 classifies the age of the person having the corresponding face into the second age range “ages of 60 or more” based on the feature quantity of the face input by the second-stage determinator 32-22, “ages of 60 or more,” which is the classification result, is supplied to the estimation result holding unit 33.

As described above, the number of stages N (levels N) in the multi-stage determining unit 32 is 3 in the present embodiment.

The estimation result holding unit 33 holds the classification result output from the determinator 32 as an estimation result. As the classification result supplied from the determinator 32, there are 7 age ranges including “ages of 0 to 9,” “ages of 10 to 19,” “ages of 20 to 29,” “ages of 30 to 39,” “ages of 40 to 49,” “ages of 50 to 59,” and “ages of 60 or more.” The estimation result holding unit 33 holds the received classification result as the age estimation result, and supplies the age estimation result to the result display unit 14.

A process (hereinafter referred to as an “age estimation process”) executed by the age estimating apparatus 1 will be described.

### [Age Estimating Process]

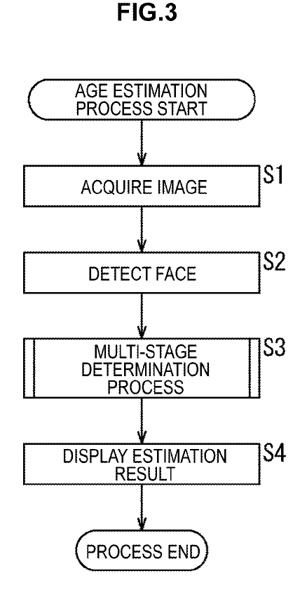

FIG. 3 is a flowchart for explaining the flow of the age estimation process.

In step S1, the image acquiring unit 11 acquires an image P including a facial image H of a subject.

In step S2, the face detecting unit 12 detects the facial image H from the image P including the facial image H of the subject acquired by the image acquiring unit 11.

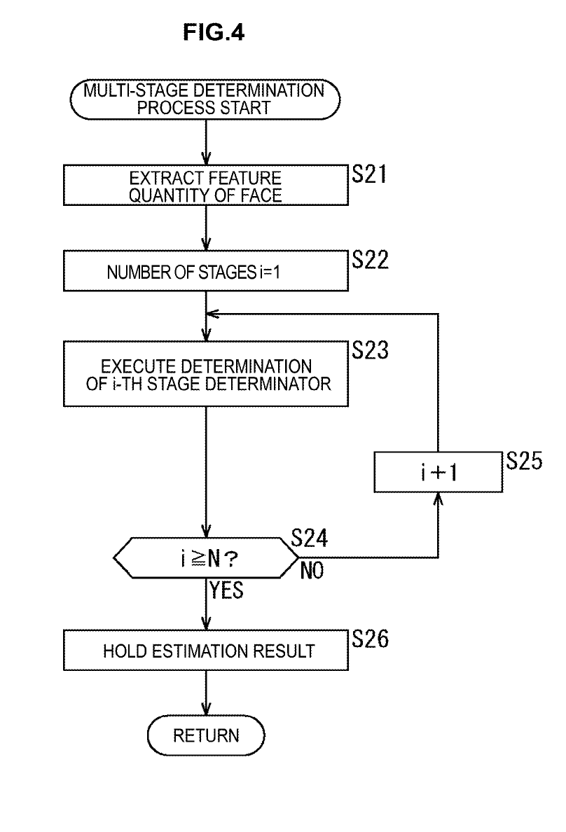

In step S3, the age estimating unit 13 executes a multi-stage determination process. The multi-stage determination process will be described later with reference to FIG. 4.

In step S4, the result display unit 14 displays an age estimation result obtained by the age estimating unit 13.

Then, the age estimation process ends.

Next, the multi-stage determination process of step S3 will be described.

### [Multi-Stage Determination Process]

FIG. 4 is a flowchart for explaining the flow of the multi-stage determination process.

In step S21, the face feature quantity extracting unit 31 extracts a feature quantity of a face from the facial image H detected by the face detecting unit 12.

In step S22, the multi-stage determining unit 32 sets the numbers of stages i of the determinator 32 of a processing target to 1. In other words, the multi-stage determining unit 32 sets the first-stage determinator 32-1 as the determinator 32 of the processing target.

In step S23, the multi-stage determining unit 32 executes determination of the i-th determinator 32, that is, determination of the first-stage determinator 32-1. Specifically, the first-stage determinator 32-1 determines which of the first age range “ages of 0 to 39” and the second age range “ages of 40 or more” the age of the person having the corresponding face is classified into based on the feature quantity of the face extracted by the face feature quantity extracting unit 31.

In step S24, the multi-stage determining unit 32 determines whether or not the number of stages i of the determinator 32 of the processing target is equal to or more than number of stages N (levels N) in the multi-stage determining unit 32.

In this case, since i is 1 and N is 3, a determination result in step S24 is NO, and the process proceeds to step S25.

In step S25, the multi-stage determining unit 32 increases the number of stages i by one (1) (i=2). Then, the process returns to step S23, and the process of step S23 and the subsequent processes are repeated. In other words, the processes of steps S23 to S25 are repeated until the number of stages i of the determinator 32 of the processing target is equal to or more than N (i.e., 3).

In step S23, the multi-stage determining unit 32 executes determination of the i-th determinator 32, that is, determination of the second-stage determinator 32.

Specifically, when the first-stage determinator 32-1 classifies the age of the person having the corresponding face into the first age range “ages of 0 to 39” based on the feature quantity of the face extracted by the face feature quantity extracting unit 31, the multi-stage determining unit 32 executes determination of the second-stage determinator 32-21. In other words, the second-stage determinator 32-21 determines which of the first age range “ages of 0 to 19” and the second age range “ages of 20 to 39” the age of the person having the corresponding face is classified into based on the feature quantity of the face input by the first-stage determinator 32-1.

However, when the first-stage determinator 32-1 classifies the age of the person having the corresponding face into the second age range “ages of 40 or more” based on the feature quantity of the face extracted by the face feature quantity extracting unit 31, the multi-stage determining unit 32 executes determination of the second-stage determinator 32-22. In other words, the second-stage determinator 32-22 determines which of the first age range “ages of 40 to 49” and the second age range “ages of 50 or more” the age of the person having the corresponding face is classified into based on the feature quantity of the face input by the first-stage determinator 32-1.

In step S24, the multi-stage determining unit 32 determines whether or not the number of stages i of the determinator 32 of the processing target is equal to or more than number of stages N (levels N) in the multi-stage determining unit 32.

In this case, since i is 2 and N is 3, a determination result in step S24 is NO, and the process proceeds to step S25.

In step S25, the multi-stage determining unit 32 increases the number of stages i by one (1) (i=3), and then the process returns to step S23.

In step S23, the multi-stage determining unit 32 executes determination of the i-th determinator 32, that is, determination of the third-stage determinator 32.

Specifically, when the second-stage determinator 32-21 classifies the age of the person having the corresponding face into the first age range “ages of 0 to 19” based on the feature quantity of the face input by the first-stage determinator 32-1, the multi-stage determining unit 32 executes determination of the third-stage determinator 32-31. In other words, the third-stage determinator 32-31 determines which of the first age range “ages of 0 to 9” and the second age range “ages of 10 to 19” the age of the person having the corresponding face is classified into based on the feature quantity of the face input by the second-stage determinator 32-21.

However, when the second-stage determinator 32-21 classifies the age of the person having the corresponding face into the second age range “ages of 20 to 39” based on the feature quantity of the face input by the first-stage determinator 32-1, the multi-stage determining unit 32 executes determination of the third-stage determinator 32-32. In other words, the third-stage determinator 32-32 determines which of the first age range “ages of 20 to 29” and the second age range “ages of 30 to 39” the age of the person having the corresponding face is classified into based on the feature quantity of the face input by the second-stage determinator 32-21.

Further, when the second-stage determinator 32-22 classifies the age of the person having the corresponding face into the first age range “ages of 40 to 49” based on the feature quantity of the face input by the first-stage determinator 32-1, the multi-stage determining unit 32 executes determination of the third-stage determinator 32. However, in this case, when there is actually no third-stage determinator 32 that executes the determination, the classification result of the previous stage, that is, the classification result of the second-stage determinator 32-22 in this example, is regarded as the classification result of the third-stage determinator 32 as is.

However, when the second-stage determinator 32-22 classifies the age of the person having the corresponding face into the second age range “ages of 50 or more” based on the feature quantity of the face input by the first-stage determinator 32-1, the multi-stage determining unit 32 executes determination of the third-stage determinator 32-33. In other words, the third-stage determinator 32-33 determines which of the first age range “ages of 50 to 59” and the second age range “ages of 60 or more” the age of the person having the corresponding face is classified into based on the feature quantity of the face input by the second-stage determinator 32-21.

In step S24, the multi-stage determining unit 32 determines whether or not the number of stages i of the determinator 32 of the processing target is equal to or more than number of stages N (levels N) in the multi-stage determining unit 32.

In this case, since i is 3 and N is 3, a determination result in step S24 is YES, and then the process proceeds to step S26.

In step S26, the estimation result holding unit 33 holds the estimation result. In other words, the estimation result holding unit 33 holds any one of “ages of 0 to 9” or “ages of 10 to 19” which is the classification result output from the third-stage determinator 32-31, “ages of 20 to 29” or “ages of 30 to 39” which is the classification result output from the third-stage determinator 32-32, “ages of 40 to 49” which is the classification result output from the second-stage determinator 32-22, and “ages of 50 to 59” or “ages of 60 or more” which is the classification result output from the third-stage determinator 32-33 as the estimation result.

Then, the multi-stage determination process ends.

As described above, the determinator 32 included in the multi-stage determining unit 32 can determine which of the first and second age ranges an age of a person having a corresponding face is classified into based on the feature quantity of the face extracted by the face feature quantity extracting unit 31. The learning unit 15 causes each determinator 32 to perform learning in advance in order to enable the determinator 32 to perform this determination. A process of the learning unit 15 will be described with reference to FIG. 5.

### [Process of Learning Unit 15]

FIG. 5 is a diagram for explaining a process of the learning unit 15.

The learning unit 15 includes a learning image storage unit 51, a face feature quantity extracting unit 52, and learning determinators 53-1 to 53-3. In the following, when it is unnecessary to distinguish the learning determinators 53-1 to 53-3 from one another, the learning determinators 53-1 to 53-3 are collectively referred to as a learning determinator 53.

The learning image storage unit 51 stores learning facial images HS1 to HSK (K is a total of the number of images and is equal to or more than 7 in the example of FIG. 5) of people of various ages together with their ages. When it is unnecessary to distinguish the learning facial images HS1 to HSK from one another, the learning facial images HS1 to HSK are collectively referred to as a learning facial image HS.

The face feature quantity extracting unit 52 basically has the same function and configuration as the face feature quantity extracting unit 31 of FIG. 2. In other words, the face feature quantity extracting unit 52 extracts feature quantities of faces of the learning facial image HS1 to HSK stored in the learning image storage unit 51.

The learning determinator 53 causes a predetermined determinator 32 to learn the feature quantities of the learning facial images HS which are classified into two different age ranges in order to solve a predetermined two-class determination problem. The two age ranges correspond to first and second age ranges of the determinator 32 of a learning target. In the example of FIG. 5, the learning determinator 53-1 causes the determinator 32-31 to perform learning, the learning determinator 53-2 causes the determinator 32-21 to perform learning, and the learning determinator 53-3 causes the determinator 32-1 to perform learning.

The number of learning determinators is 3 in this example, but it is not particularly limited. In other words, since learning processes of separate determinators 32 can be divided in terms of time and then individually executed by a single learning determinator, the number of learning determinators may be decided independently of a total of the number of determinators 32 of the learning target. A learning technique by the learning determinator 53 is not particularly limited, and for example, a technique such as a support vector machine (SVM) or Adaboost may be employed.

The learning determinator 53-1 causes the determinator 32-31 to perform learning to solve the two-class determination problem of the first age range “ages of 0 to 9” and the second age range “ages of 10 to 19.” Specifically, the learning determinator 53-1 causes the determinator 32-31 to perform learning in advance using only the learning facial images HS which are classified into “ages of 0 to 9” and “ages of 10 to 19” among the learning facial images HS stored in the learning image storage unit 51. In other words, the learning determinator 53-1 causes the determinator 32-31 to perform learning to output a “positive result” (corresponding to a result of “y” in FIG. 2) when the feature quantity of the learning facial image HS of “ages of 0 to 9” is extracted by the face feature quantity extracting unit 52. Further, the learning determinator 53-1 causes the determinator 32-31 to perform learning to output a “negative result” (corresponding to a result of “n” in FIG. 2) when the feature quantity of the learning facial image HS of “ages of 10 to 19” is extracted by the face feature quantity extracting unit 52. The determinator 32-31 which has completed learning by the learning determinator 53-1 in the above-described way is applied to the multi-stage determining unit 32 of FIG. 2.

The learning determinator 53-2 causes the determinator 32-21 to perform learning to solve the two-class determination problem of the first age range “ages of 0 to 19” and the second age range “ages of 20 to 39.” Specifically, the learning determinator 53-2 causes the determinator 32-21 to perform learning in advance using only the learning facial images HS which are classified into “ages of 0 to 19” and “ages of 20 to 39” among the learning facial images HS stored in the learning image storage unit 51. In other words, the learning determinator 53-2 causes the determinator 32-21 to perform learning to output a “positive result” (corresponding to a result of “y” in FIG. 2) when the feature quantity of the learning facial image HS of “ages of 0 to 19” is extracted by the face feature quantity extracting unit 52. Further, the learning determinator 53-2 causes the determinator 32-21 to perform learning to output a “negative result” (corresponding to a result of “n” in FIG. 2) when the feature quantity of the learning facial image HS of “ages of 20 to 39” is extracted by the face feature quantity extracting unit 52. The determinator 32-21 which has completed learning through the learning determinator 53-2 as described above is applied to the multi-stage determining unit 32 of FIG. 2.

The learning determinator 53-3 causes the determinator 32-1 to perform learning to solve the two-class determination problem of the first age range “ages of 0 to 39” and the second age range “ages of 40 or more.” Specifically, the learning determinator 53-3 causes the determinator 32-1 to perform learning in advance using only the learning facial images HS which are classified into “ages of 0 to 39” and “ages of 40 or more” among the learning facial images HS stored in the learning image storage unit 51. In other words, the learning determinator 53-3 causes the determinator 32-1 to perform learning to output a “positive result” (corresponding to a result of “y” in FIG. 2) when the feature quantity of the learning facial image HS of “ages of 0 to 39” is extracted by the face feature quantity extracting unit 52. Further, the learning determinator 53-3 causes the determinator 32-1 to perform learning to output a “negative result” (corresponding to a result of “n” in FIG. 2) when the feature quantity of the learning facial image HS of “ages of 40 or more” is extracted by the face feature quantity extracting unit 52. The determinator 32-1 which has completed learning through the learning determinator 53-3 as described above is applied to the multi-stage determining unit 32 of FIG. 2.

Since the learning unit 15 can cause each determinator 32 to learn only data (two age ranges in this case) used in the two class determination problem which has to be solved by the corresponding determinator 32 in advance as described above, efficient learning using a small amount of data can be performed. For example, the learning determinator 53-2 can cause the determinator 32-21 to learn only the feature quantities of the learning facial images HS of “ages of 0 to 19” and “ages of 20 to 39,” and the feature quantity of the learning facial image HS of “ages of 40 or more” need not be used for learning. Thus, efficient learning using a small amount of data can be performed.

Further, the multi-stage determining unit 32 is configured with the determinators 32 in the tree structure, and only one determinator 32 specified by the determination result of the previous stage executes a determination in each stage. Thus, compared to when all of the determinators 32 perform a determination, the processing speed can be improved.

The learning image storage unit 51 may store a learning facial image of a person together with an appearance age. In this case, two different appearance age ranges are assigned to each determinator 32 as two classes, and each determinator 32 determines which of the two appearance age ranges an appearance age of a person having a corresponding face is classified into based on an input feature quantity of a face. Thus, the learning determinator 53 causes a predetermined determinator 32 to learn the feature quantities of the learning facial images classified into the two different appearance age ranges to solve a predetermined two-class determination problem.

### 2. Second Embodiment

The two age ranges used in the two-class determination problem solved by each determinator 32 of the first embodiment do not overlap in the corresponding determinator 32 or the other determinators 32. However, the two age ranges used in the two-class determination problem solved by each determinator 32 may overlap in the corresponding determinator or the other determinators. In other words, determinators to which two age ranges having a margin (that is, an overlapping portion) are assigned may be arranged in the multi-stage determining unit. In this case, even when an age that would be close to an upper limit or a lower limit of a predetermined age range if there were no margin is set as a processing target, erroneous classification can be suppressed.

In this regard, an age estimating apparatus including determinators to which two age ranges having a margin are assigned will be described as a second embodiment. The age estimating apparatus according to the second embodiment basically has the same function and configuration as the age estimating apparatus 1 of FIG. 1. Thus, the same points as in the age estimating apparatus 1 of FIG. 1 will not be described below, and a description will be made in connection with different points, that is, an age estimating unit 71, which is different from the age estimating unit 13 of the age estimating apparatus 1 of FIG. 1.

### [Configuration Example of Age Estimating Unit 71]

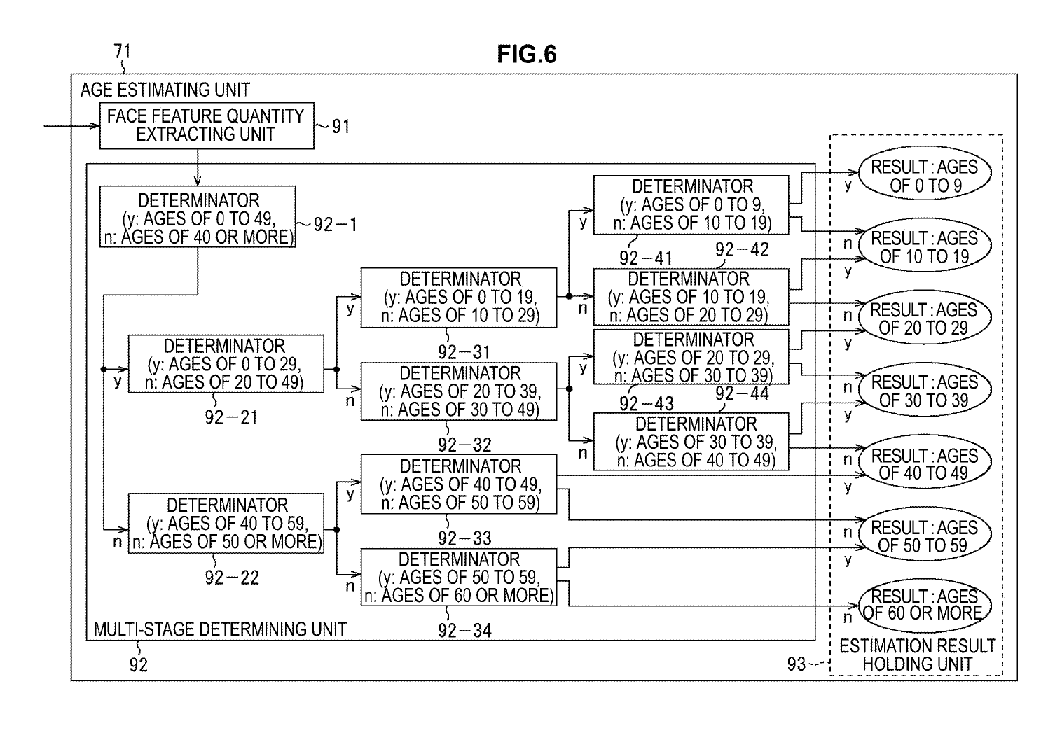

FIG. 6 is a diagram illustrating a detailed configuration example of the age estimating unit 71.

The age estimating unit 71 includes a face feature quantity extracting unit 91, a multi-stage determining unit 92, and an estimation result holding unit 93.

The face feature quantity extracting unit 91 basically has the same function and configuration as the face feature quantity extracting unit 31 of FIG. 2, and thus the redundant description will not be repeated.

The multi-stage determining unit 92 determines which one of a plurality of previously set age ranges an age of a person having a corresponding face is classified into based on the feature quantity of the face extracted by the face feature quantity extracting unit 91. The multi-stage determining unit 92 includes a determinator 92-1, determinators 92-21 and 92-22, determinators 92-31 to 92-34, and determinators 92-41 to 92-44.

When the determinator 92-1 is arranged as a first-stage node, the determinators 92-21 and 92-22 are arranged as second-stage nodes which are one stage lower than the determinator 92-1. Further, the determinators 92-31 and 92-32 are arranged as third-stage nodes which are one stage lower than the determinator 92-21. Further, the determinators 92-33 and 92-34 are arranged as third-stage nodes which are one stage lower than the determinator 92-22. Further, the determinators 92-41 and 92-42 are arranged as fourth-stage nodes which are one stage lower than the determinator 92-31. Further, the determinators 92-43 and 92-44 are arranged as fourth-stage nodes which are one stage lower than the determinator 92-32. As described above, in the present embodiment, the multi-stage determining unit 92 is configured with nodes of a four-level tree structure such as the determinators 92-1, 92-21, 92-22, 92-31 to 92-34, and 92-41 to 92-44.

In the following, when it is unnecessary to distinguish the determinators 92-1, 92-21, 92-22, 92-31 to 92-34, and 92-41 to 92-44 from one another, the determinators 92-1, 92-21, 92-22, 92-31 to 92-34, and 92-41 to 92-44 are collectively referred to as a “determinator 92.”

Each determinator 92 solves the 2-class determination problem. In other words, in the present embodiment, two different age ranges having a margin are assigned to each determinator 92 as two classes. Thus, each determinator 932 determines which one of two age ranges an age of a person having a corresponding face is classified into based on the input feature quantity of the face.

Specifically, a first age range “ages of 0 to 49” and a second age range “ages of 40 or more” are assigned to the first-stage determinator 92-1 as 2 classes represented as “y: ages of 0 to 49, n: ages of 40 or more” in FIG. 6. Thus, the first-stage determinator 92-1 determines which of the first and second age ranges an age of a person having a corresponding face is classified into based on the feature quantity of the face extracted by the face feature quantity extracting unit 91. The two age ranges having a margin of a range of “ages of 40 to 49” are assigned to the first-stage determinator 92-1.

When the first-stage determinator 92-1 classifies the age of the person having the corresponding face into the first age range “ages of 0 to 49” based on the feature quantity of the face extracted by the face feature quantity extracting unit 91, the feature quantity of the face is supplied to the second-stage determinator 92-21 together with the classification result. However, when the first-stage determinator 92-1 classifies the age of the person having the corresponding face into the second age range “ages of 40 or more” based on the feature quantity of the face extracted by the face feature quantity extracting unit 91, the feature quantity of the face is supplied to the second-stage determinator 92-22 together with the classification result.

A first age range “ages of 0 to 29” and a second age range “ages of 20 to 49” are assigned to the second-stage determinator 92-21 as two classes represented as “y: ages of 0 to 29, n: ages of 20 to 49” in FIG. 6. Thus, the second-stage determinator 92-21 determines which of the first and second age ranges an age of a person having a corresponding face is classified into based on the feature quantity of the face input by the first-stage determinator 92-1. The two age ranges having a margin of a range of “ages of 20 to 29” are assigned to the second-stage determinator 92-21.

When the second-stage determinator 92-21 classifies the age of the person having the corresponding face into the first age range “ages of 0 to 29” based on the feature quantity of the face input by the first-stage determinator 92-1, the feature quantity of the face is supplied to the third-stage determinator 92-31 together with the classification result. However, when the second-stage determinator 92-21 classifies the age of the person having the corresponding face into the second age range “ages of 20 to 49” based on the feature quantity of the face input by the first-stage determinator 92-1, the feature quantity of the face is supplied to the third-stage determinator 92-32 together with the classification result.

A first age range “ages of 40 to 59” and a second age range “ages of 50 or more” are assigned to the second-stage determinator 92-22 as two classes represented as “y: ages of 40 to 59, n: ages of 50 or more” in FIG. 6. Thus, the second-stage determinator 92-22 determines which of the first and second age ranges the age of the person having the corresponding face is classified into based on the feature quantity of the face input by the first-stage determinator 92-1. The two age ranges having a margin of a range of “ages of 50 to 59” are assigned to the second-stage determinator 92-22.

When the second-stage determinator 92-22 classifies the age of the person having the corresponding face into the first age range “ages of 40 to 59” based on the feature quantity of the face input by the first-stage determinator 92-1, the feature quantity of the face is supplied to the third-stage determinator 92-33 together with the classification result. However, when the second-stage determinator 92-22 classifies the age of the person having the corresponding face into the second age range “ages of 50 or more” based on the feature quantity of the face input by the first-stage determinator 92-1, the feature quantity of the face is supplied to the third-stage determinator 92-34 together with the classification result.

A first age range “ages of 0 to 19” and a second age range “ages of 10 to 29” are assigned to the third-stage determinator 92-31 as two classes represented as “y: ages of 0 to 19, n: ages of 10 to 29” in FIG. 6. Thus, the third-stage determinator 92-31 determines which of the first and second age ranges the age of the person having the corresponding face is classified into based on the feature quantity of the face input by the second-stage determinator 92-21. The two age ranges having a margin of a range of “ages of 10 to 19” are assigned to the third-stage determinator 92-31.

When the third-stage determinator 92-31 classifies the age of the person having the corresponding face into the first age range “ages of 0 to 19” based on the feature quantity of the face input by the second-stage determinator 92-21, the feature quantity of the face is supplied to the fourth determinator 92-41 together with the classification result. However, when the third-stage determinator 92-31 classifies the age of the person having the corresponding face into the second age range “ages of 10 to 29” based on the feature quantity of the face input by the second-stage determinator 92-21, the feature quantity of the face is supplied to the fourth determinator 92-42 together with the classification result.

A first age range “ages of 20 to 39” and a second age range “ages of 30 to 49” are assigned to the third-stage determinator 92-32 as two classes represented as “y: ages of 20 to 39, n: ages of 30 to 49” in FIG. 6. Thus, the third-stage determinator 92-32 determines which of the first and second age ranges the age of the person having the corresponding face is classified into based on the feature quantity of the face input by the second-stage determinator 92-21. The two age ranges having a margin of a range of “ages of 30 to 39” are assigned to the third-stage determinator 92-32.

When the third-stage determinator 92-32 classifies the age of the person having the corresponding face into the first age range “ages of 20 to 39” based on the feature quantity of the face input by the second-stage determinator 92-21, the feature quantity of the face is supplied to the fourth determinator 92-43 together with the classification result. However, when the third-stage determinator 92-32 classifies the age of the person having the corresponding face into the second age range “ages of 30 to 49” based on the feature quantity of the face input by the second-stage determinator 92-21, the feature quantity of the face is supplied to the fourth determinator 92-44 together with the classification result.

A first age range “ages of 40 to 49” and a second age range “ages of 50 to 59” are assigned to the third-stage determinator 92-33 as two classes represented as “y: ages of 40 to 49, n: ages of 50 to 59” in FIG. 6. Thus, the third-stage determinator 92-33 determines which of the first and second age ranges the age of the person having the corresponding face is classified into based on the feature quantity of the face input by the second-stage determinator 92-22. The two age ranges having a margin of a range of “ages of 49 to 50” are assigned to the third-stage determinator 92-33.

When the third-stage determinator 92-33 classifies the age of the person having the corresponding face into the first age range “ages of 40 to 49” based on the feature quantity of the face input by the second-stage determinator 92-22, “ages of 40 to 49,” which is the classification result, is supplied to the estimation result holding unit 93. However, when the third-stage determinator 92-33 classifies the age of the person having the corresponding face into the second age range “ages of 50 to 59” based on the feature quantity of the face input by the second-stage determinator 92-22, “ages of 50 to 59,” which is the classification result, is supplied to the estimation result holding unit 93.

A first age range “ages of 50 to 59” and a second age range “ages of 60 or more” are assigned to the third-stage determinator 92-34 as two classes represented as “y: ages of 50 to 59, n: ages of 60 or more” in FIG. 6. Thus, the third-stage determinator 92-34 determines which of the first and second age ranges the age of the person having the corresponding face is classified into based on the feature quantity of the face input by the second-stage determinator 92-22.

When the third-stage determinator 92-34 classifies the age of the person having the corresponding face into the first age range “ages of 50 to 59” based on the feature quantity of the face input by the second-stage determinator 92-22, “ages of 50 to 59,” which is the classification result, is supplied to the estimation result holding unit 93. However, when the third-stage determinator 92-34 classifies the age of the person having the corresponding face into the second age range “ages of 60 or more” based on the feature quantity of the face input by the second-stage determinator 92-22, “ages of 60 or more,” which is the classification result, is supplied to the estimation result holding unit 93.

A first age range “ages of 0 to 9” and a second age range “ages of 10 to 19” are assigned to the fourth-stage determinator 92-41 as two classes represented as “y: ages of 0 to 9, n: ages of 10 to 19” in FIG. 6. Thus, the fourth-stage determinator 92-41 determines which of the first and second age ranges the age of the person having the corresponding face is classified into based on the feature quantity of the face input by the third-stage determinator 92-31.

When the fourth-stage determinator 92-41 classifies the age of the person having the corresponding face into the first age range “ages of 0 to 9” based on the feature quantity of the face input by the third-stage determinator 92-31, “ages of 0 to 9,” which is the classification result, is supplied to the estimation result holding unit 93. However, when the fourth-stage determinator 92-41 classifies the age of the person having the corresponding face into the second age range “ages of 10 to 19” based on the feature quantity of the face input by the third-stage determinator 92-31, “ages of 10 to 19,” which is the classification result, is supplied to the estimation result holding unit 93.

A first age range “ages of 10 to 19” and a second age range “ages of 20 to 29” are assigned to the fourth-stage determinator 92-42 as two classes represented as “y: ages of 10 to 19, n: ages of 20 to 29” in FIG. 6. Thus, the fourth-stage determinator 92-42 determines which of the first and second age ranges the age of the person having the corresponding face is classified into based on the feature quantity of the face input by the third-stage determinator 92-31.

When the fourth-stage determinator 92-42 classifies the age of the person having the corresponding face into the first age range “ages of 10 to 19” based on the feature quantity of the face input by the third-stage determinator 92-31, “ages of 10 to 19,” which is the classification result, is supplied to the estimation result holding unit 93. However, when the fourth-stage determinator 92-42 classifies the age of the person having the corresponding face into the second age range “ages of 20 to 29” based on the feature quantity of the face input by the third-stage determinator 92-31, “ages of 20 to 29,” which is the classification result, is supplied to the estimation result holding unit 93.

A first age range “ages of 20 to 29” and a second age range “ages of 30 to 39” are assigned to the fourth-stage determinator 92-43 as two classes represented as “y: ages of 20 to 29, n: ages of 30 to 39” in FIG. 6. Thus, the fourth-stage determinator 92-43 determines which of the first and second age ranges the age of the person having the corresponding face is classified into based on the feature quantity of the face input by the third-stage determinator 92-32.

When the fourth-stage determinator 92-43 classifies the age of the person having the corresponding face into the first age range “ages of 20 to 29” based on the feature quantity of the face input by the third-stage determinator 92-32, “ages of 20 to 29,” which is the classification result, is supplied to the estimation result holding unit 93. However, when the fourth-stage determinator 92-43 classifies the age of the person having the corresponding face into the second age range “ages of 30 to 39” based on the feature quantity of the face input by the third-stage determinator 92-32, “ages of 30 to 39,” which is the classification result, is supplied to the estimation result holding unit 93.

A first age range “ages of 30 to 39” and a second age range “ages of 40 to 49” are assigned to the fourth-stage determinator 92-44 as two classes represented as “y: ages of 30 to 39, n: ages of 40 to 49” in FIG. 6. Thus, the fourth-stage determinator 92-44 determines which of the first and second age ranges the age of the person having the corresponding face is classified into based on the feature quantity of the face input by the third-stage determinator 92-32.

When the fourth-stage determinator 92-44 classifies the age of the person having the corresponding face into the first age range “ages of 30 to 39” based on the feature quantity of the face input by the third-stage determinator 92-32, “ages of 30 to 39,” which is the classification result, is supplied to the estimation result holding unit 93. However, when the fourth-stage determinator 92-44 classifies the age of the person having the corresponding face into the second age range “ages of 40 to 49” based on the feature quantity of the face input by the third-stage determinator 92-32, “ages of 40 to 49,” which is the classification result, is supplied to the estimation result holding unit 93.

As described above, a number of stages N (levels N) of the multi-stage determining unit 92 is 4 in the present embodiment.

The estimation result holding unit 93 holds the classification result output from the determinator 92 as an estimation result. As the classification result supplied from the determinator 92, there are 7 age ranges including “ages of 0 to 9,” “ages of 10 to 19,” “ages of 20 to 29,” “ages of 30 to 39,” “ages of 40 to 49,” “ages of 50 to 59,” and “ages of 60 or more.” The estimation result holding unit 93 holds the received classification result as the age estimation result, and supplies the age estimation result to the result display unit 14.

The multi-stage determination process by the age estimating unit 71 is basically the same as in FIG. 4, and the redundant description will not be repeated.

By arranging the determinators 92 to which the two age ranges having a margin are assigned as described above, erroneous classification can be suppressed even on data that would be close to an upper limit or a lower limit of a predetermined age range if there were no margin.

For example, in a determination by a determinator for solving the two-class determination problem having no margin like the first age range “ages of 0 to 39” and the second age range “ages of 40 or more,” it is ambiguous which of “ages of 0 to 39” and “ages of 40 or more” a face of a person at the age of 40 is classified into. Thus, when erroneous classification (that is, classification into the age range of “ages of 0 to 39”) has been made, an erroneous classification result is input to a determinator of a lower stage. Thus, it is ultimately difficult to estimate (determine) a correct age.

For example, in a determination by a determinator for solving the two-class determination problem having a margin in a range of “ages of 40 to 49” like the first age range “ages of 0 to 49” and the second age range “ages of 40 or more,” the above difficulty is resolved. In other words, whether the determinator 92-1 classifies a face of a person at the age of 40 into the first age range “ages of 0 to 49” or the second age range “ages of 40 or more,” a correct classification is made. Thus, thereafter, a correct classification result is input to the second-stage determinator 92-21 or 92-22 which is one stage lower than the determinator 92-1, and a determination having a margin in a predetermined range, that is, a determination by which a correct classification result is obtained, is performed.

As described above, a classification result of a previous stage having no error is input to a determinator of any stage, and thus a determination having a margin in a predetermined range, that is, a determination by which a correct classification result is obtained, is performed. As a result, a classification result output from a determinator 92 of a lowest stage becomes a correctly estimated age having little error. A concrete example will be described below in detail.

For example, an example in which the multi-stage determination process is executed on a face of a person at the age of 26 will be described.

First, the first determinator 92-1 of the multi-stage determining unit 92 determines which one of the first age range “ages of 0 to 49” and the second age range “ages of 40 or more” the age of the person having the corresponding face is classified into based on a feature quantity of the face of the person at the age of 26. As a result, the first determinator 92-1 determines that the age of the person is classified into “ages of 0 to 49.”

Next, the second-stage determinator 92-21 of the multi-stage determining unit 92 classifies which one of the first age range “ages of 0 to 29” and the second age range “ages of 20 to 49” the age of the person is classified into As a result, the second-stage determinator 92-21 may determine that the age of the person is classified into “ages of 0 to 29” or may determine that the age of the person is classified into “ages of 20 to 49.” This is because the feature quantities of faces of people at the age of 26 may differ naturally according to a personal differences such as an older-looking face or a younger-looking face, and even the face of the same person may differ according to a difference in a shooting condition such as lighting or a change in a personal heath state.

When the second-stage determinator 92-21 determines that the face of the person is classified into “ages of 0 to 29,” the third-stage determinator 92-31 of the multi-stage determining unit 92 determines which of the first age range “ages of 0 to 19” and the second age range “ages of 10 to 29” the age of the person is classified into. As a result, the third-stage determinator 92-31 determines that the age of the person is classified into “ages of 10 to 29.” Next, the fourth-stage determinator 92-42 of the multi-stage determining unit 92 determines which of the first age range “ages of 10 to 19” and the second age range “ages of 20 to 29” the age of the person is classified into. As a result, the fourth-stage determinator 92-42 determines that the age of the person is classified into “ages of 20 to 29.” As a result, the estimation result holding unit 93 holds a classification result of “ages of 20 to 29” output from the fourth-stage determinator 92-42 as an estimation result.

When the second-stage determinator 92-21 determines that the face of the person is classified into “ages of 20 to 49,” the third-stage determinator 92-32 of the multi-stage determining unit 92 determines which of the first age range “ages of 20 to 39” and the second age range “ages of 30 to 49” the age of the person is classified into. As a result, the third-stage determinator 92-32 determines that the age of the person is classified into “ages of 20 to 39.” Next, the fourth-stage determinator 92-43 of the multi-stage determining unit 92 determines which of the first age range “ages of 20 to 29” and the second age range “ages of 30 to 39” the age of the person is classified into. As a result, the fourth-stage determinator 92-43 determines that the age of the person is classified into “ages of 20 to 29.” As a result, the estimation result holding unit 93 holds a classification result of “ages of 20 to 29” output from the fourth-stage determinator 92-43 as an estimation result.

As described above, whether the second-stage determinator 92-21 classifies the age of the person at the age of 26 into “ages of 0 to 29” or “ages of 20 to 49,” the estimation result holding unit 93 holds the classification result of “ages of 20 to 29” as the estimation result. In other words, since a classification result of a previous stage having no error is input to a predetermined determinator 92 and then a determination is made, a classification result output from a determinator 92 of a lowest stage becomes a correctly estimated age having little error.

Next, a process of a learning unit 115 on the determinator 92, which solves the two-class determination problem having a margin, included in the multi-stage determining unit 92 will be described.

### [Process of Learning Unit 115]

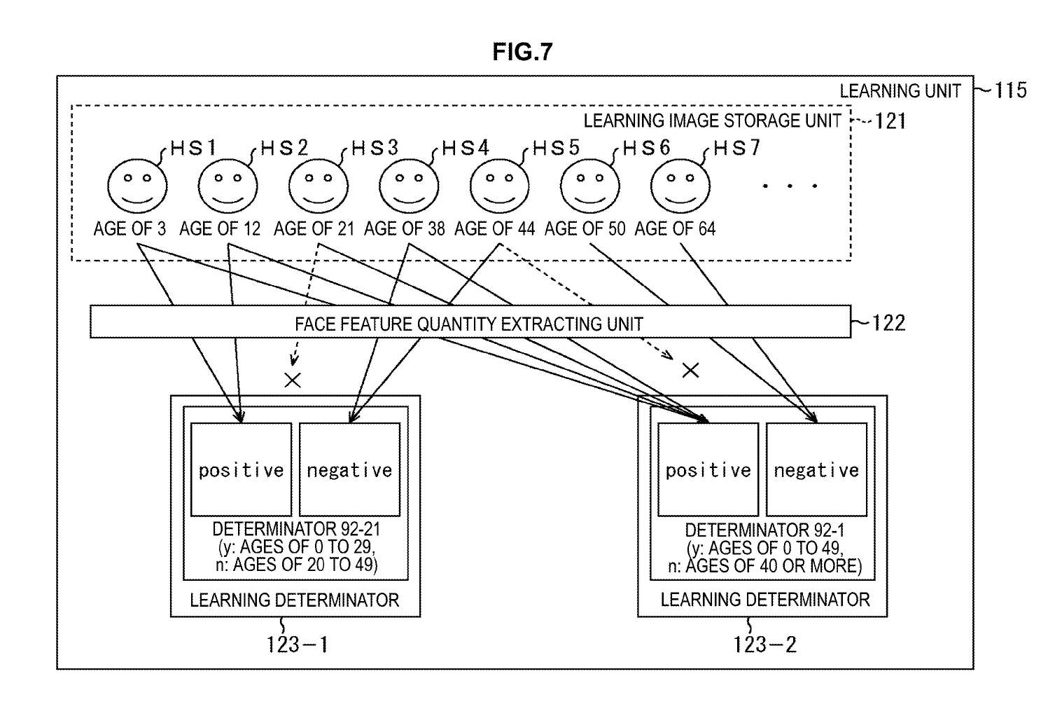

FIG. 7 is a diagram for explaining a process of the learning unit 115.

The learning unit 115 includes a learning image storage unit 121, a face feature quantity extracting unit 122, and learning determinators 123-1 and 123-2. Hereinafter, when it is unnecessary to distinguish the learning determinators 123-1 and 123-12 from each other, the learning determinators 123-1 and 123-12 are collectively referred to as a learning determinator 123.

The learning image storage unit 121 and the face feature quantity extracting unit 122 basically have the same function and configuration as the learning image storage unit 51 and the face feature quantity extracting unit 52 of FIG. 5, and thus the redundant description will not be repeated.

The learning determinator 123 causes the determinator 92 to learn the feature quantities of the learning facial images HS which are classified into two different age ranges in order to solve the two-class determination problem having a margin. In the example of FIG. 7, the learning determinator 123-1 causes the determinator 92-21 to perform learning, and the learning determinator 123-2 causes the determinator 92-1 to perform learning.

The learning determinator 123-1 causes the determinator 92-21 to perform learning to solve the two-class determination problem with a margin of the first age range “ages of 0 to 29” and the second age range “ages of 20 to 49.” Specifically, the learning determinator 123-1 causes the determinator 92-21 to perform learning in advance using only the learning facial images HS which are classified into “ages of 0 to 19” and “ages of 30 to 49” among the learning facial images HS stored in the learning image storage unit 121. At this time, the learning determinator 123-1 does not use the feature quantity of the learning facial images HS present within a range of “ages of 20 to 29” corresponding to the margin of the two-class determination problem of the determinator 92-21 for learning.

In other words, the learning determinator 123-1 causes the determinator 92-21 to perform learning to output a “positive result” (corresponding to a result of “y” in FIG. 6) when the feature quantity of the learning facial image HS of “ages of 0 to 19” is extracted by the face feature quantity extracting unit 122. Further, the learning determinator 123-1 causes the determinator 92-21 to perform learning to output a “negative result” (corresponding to a result of “n” in FIG. 6) when the feature quantity of the learning facial image HS of “ages of 30 to 49” is extracted by the face feature quantity extracting unit 122.

As a result, for example, in the case of a person having a predetermined age within a range of “ages of 20 to 29,” the determinator 92-21 classifies the age of the person into “ages of 0 to 19” when a face quantity of a face is closer to “ages of 0 to 19.” Thus, the multi-stage determining unit 92 can execute a determination by the second-stage determinator 92-31. However, when the feature quantity of the face of the person is closer to “ages of 30 to 49,” the age of the person is classified into “ages of 30 to 49.” Thus, the multi-stage determining unit 92 can execute a determination by the second-stage determinator 92-32.

The determinator 92-21 which has completed learning by the learning determinator 123-1 as described above is applied to the multi-stage determining unit 92 of FIG. 6.

Further, the learning determinator 123-2 causes the determinator 92-1 to perform learning to solve the two-class determination problem with a margin of the first age range “ages of 0 to 49” and the second age range “ages of 40 or more.” Specifically, the learning determinator 123-2 causes the determinator 92-1 to perform learning in advance using only the learning facial images HS which are classified into “ages of 0 to 39” and “ages of 50 or more” among the learning facial images HS stored in the learning image storage unit 121. At this time, the learning determinator 123-2 does not use the feature quantity of the learning facial images HS present within a range of “ages of 40 to 49” corresponding to the margin of the two-class determination problem of the determinator 92-1 for learning.

In other words, the learning determinator 123-2 causes the determinator 92-1 to perform learning to output a “positive result” (corresponding to a result of “y” in FIG. 6) when the feature quantity of the learning facial image HS of “ages of 0 to 39” is extracted by the face feature quantity extracting unit 122. Further, the learning determinator 123-2 causes the determinator 92-1 to perform learning to output a “negative result” (corresponding to a result of “n” in FIG. 6) when the feature quantity of the learning facial image HS of “ages of 50 or more” is extracted by the face feature quantity extracting unit 122.

As a result, for example, in the case of a person having a predetermined age within a range of “ages of 40 to 49,” the determinator 92-1 classifies the age of the person into “ages of 0 to 39” when a face quantity of a face is closer to “ages of 0 to 39.” Thus, the multi-stage determining unit 92 can execute a determination by the second-stage determinator 92-21. However, when the feature quantity of the face of the person is closer to “ages of 50 or more,” the age of the person is classified into “ages of 50 or more.” Thus, the multi-stage determining unit 92 can execute a determination by the second-stage determinator 92-22.

Since the learning unit 115 can cause each determinator 92 to learn only data (two age ranges having a margin in this case) used in the two class determination problem which has to be solved by the corresponding determinator 92 in advance as described above, efficient learning using a small amount of data can be performed.

Further, the multi-stage determining unit 92 is configured with the determinators 92 of the tree structure, and only one determinator 92 specified by the determination result of the previous stage executes a determination in each stage. Thus, compared to when all of the determinators 92 perform a determination, the processing speed can be improved.

Further, by arranging the determinators 92 to which the two age ranges having a margin are assigned, erroneous classification can be suppressed even on an age that would be close to an upper limit or a lower limit of a predetermined age range if there were no margin.

### 3. Third Embodiment

Outputs of the determinator 32 and the determinator 92 according to the first and second embodiments are one of two age ranges represented by “y” or “n,” that is, a binary value. However, an output of each determinator may be a likelihood numerical value. For an age which is likely to be erroneously classified in a predetermined determinator, for example, for an age close to an upper limit or a lower limit of an age range used in the two-class determination problem, the determination process ends midstream, and the corresponding age is classified into a classification result having a broad age range.

As a result, an age which is likely to be erroneously classified can be estimated with little error. In this regard, an age estimating apparatus including a determinator whose output is a likelihood numerical value will be described as a third embodiment. The age estimating apparatus according to the third embodiment basically has the same function and configuration as the age estimating apparatus according to the second embodiment. Thus, in the following, points that are the same as in the age estimating apparatus according to the second embodiment will not be described, and a description will be made in connection with different points, that is, a multi-stage determining unit 132 and an estimation result holding unit 133, which are different from the multi-stage determining unit 92 and the estimation result holding unit 93 of FIG. 6.

### [Configuration Example of Multi-Stage Determining Unit 132 and Estimation Result Holding Unit 133]

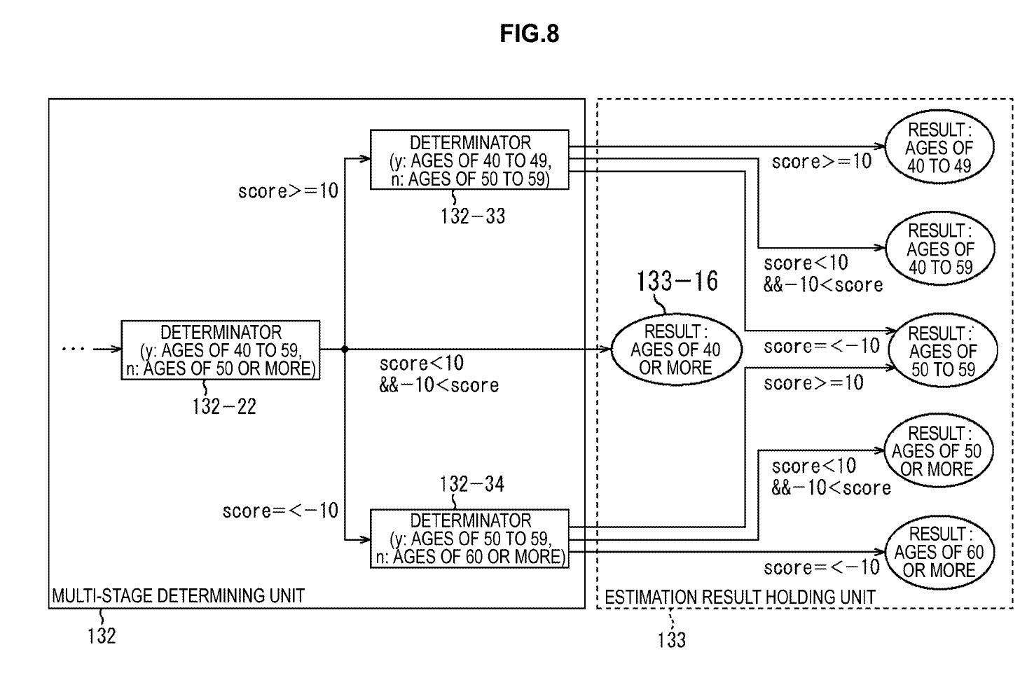

FIG. 8 is a diagram illustrating a configuration example of the multi-stage determining unit 132 and the estimation result holding unit 133.

In the multi-stage determining unit 132 of FIG. 8, only a second-stage determinator 132-22 and third-stage determinators 132-33 and 132-34 are illustrated as the same determinators as the second-stage determinator 92-22 and the third-stage determinators 92-33 and 92-34 of the multi-stage determining unit 92 of FIG. 6. Thus, the redundant description of the determinators will not be repeated. Two age ranges with a margin are assigned to the second-stage determinator 132-22 and the third-stage determinator 132-33. In the following, when it is unnecessary to distinguish the determinators 132-22, 132-33, and 132-34 from one another, the determinators 132-22, 132-33, and 132-34 are collectively referred to as a determinator 132.

Each determinator 132 determines a predetermined score within a range of −100 to 100 based on an input feature quantity, and then outputs the determined score.

Here, if a classification into an age range represented by “y” is made by the two-class determination problem when an output score value from the determinator 132 is a positive value (from 1 to 100) and a classification into an age range represented by “n” is made by the two-class determination problem when an output score value is a negative value (from −1 to −100), the following problem occurs. In other words, when the output score value is a score close to a positive boundary, for example, +1, a classification into an age range represented by “y” is made. However, the age range represented by “y” is not necessarily appropriate, and an age range represented by “n” may be appropriate instead. Similarly, when the output score value is a score close to a negative boundary, for example, −1, a classification into an age range represented by “n” is made. However, the age range represented by “n” is not necessarily appropriate, and an age range represented by “y” may be appropriate instead. In other words, a case in which the output score value falls within a range close to the positive and negative boundaries is not a case in which a classification into any one of age ranges represented by “y” or “n” can be clearly made but an ambiguous case.

In this regard, in the present embodiment, when the output score value of the determinator 132 falls within a range close to the positive and negative boundaries, for example, when the output score value falls within a range of −10 to 10, the determination process ends midstream. In other words, a certain range from the boundary between the two age ranges in the two-class determination problem is set as a dead zone range in advance, and when an output of the determinator 132 is classified into the dead zone range, the determination process by a determinator of a next stage is not performed and ends midstream. As a result, an erroneous classification into an age range represented by “y” or “n” can be suppressed.

Referring to FIG. 8, when an output from the determinator 132-22 is represented as “score≧10,” that is, when the output score value is equal to or more than 10, the multi-stage determining unit 132 executes a determination by the determinator 132-33. However, when the output from the determinator 132-22 is represented as “score≦−10,” that is, when the output score value is equal to or less than −10, the multi-stage determining unit 132 executes a determination by the determinator 132-34. Further, when the output from the determinator 132-22 is represented as “score<10 && −10<score,” that is, when the output score value is smaller than 10 and larger than −10, “ages of 40 or more” is output as a classification result and then held in the estimation result holding unit 133. In other words, in this case, a subsequent determination process ends midstream, and a classification into a classification result having a broad age range is made.

Then, when the output from the determinator 132-33 is represented as “score≧10,” that is, when the output score value is equal to or more than 10, “ages of 40 to 49” is output as a classification result and then held in the estimation result holding unit 133. However, when the output from the determinator 132-33 is represented as “score≦−10,” that is, when the output score value is equal to or less than −10, “ages of 50 to 59” is output as a classification result and then held in the estimation result holding unit 133. Further, when the output from the determinator 132-33 is represented as “score<10 && −10<score,” that is, when the output score value is smaller than 10 and larger than −10, “ages of 40 to 59” is output as a classification result and then held in the estimation result holding unit 133.

Further, when the output from the determinator 132-34 is represented as “score≧10,” that is, when the output score value is equal to or more than 10, “ages of 50 to 59” is output as a classification result and then held in the estimation result holding unit 133. However, when the output from the determinator 132-34 is represented as “score≦10,” that is, when the output score value is equal to or less than −10, “ages of 50 or more” is output as a classification result and then held in the estimation result holding unit 133. Further, when the output from the determinator 132-34 is represented as “score<10 && −10<score,” that is, when the output score value is smaller than 10 and larger than −10, “ages of 60 or more” is output as a classification result and then held in the estimation result holding unit 133.

A concrete example will be described below in detail.

For example, the determinator 132-22 of the multi-stage determining unit 132 determines which of the first age range “ages of 40 to 59” and the second age range “50 or more” an age of a person having a corresponding face is classified into based on a feature quantity of a face extracted by a face feature quantity extracting unit (not shown). When the output score value from the determinator 132-22 is 70, it is determined that the age of the person having the corresponding face is classified into “ages of 40 to 59.” Thus, the multi-stage determining unit 132 executes a determination by the determinator 132-33.

However, when the output score value from the determinator 132-22 is −30, it is determined that the age of the person having the corresponding face is classified into “ages of 50 or more.” Thus, the multi-stage determining unit 132 executes a determination by the determinator 132-34.

Meanwhile, when the output score value from the determinator 132-22 is 1, a determination about which of the first age range “ages of 40 to 59” and the second age range “50 or more” an age of a person having a corresponding face is classified into is not performed, and the determination ends midstream. In other words, “ages of 40 or more” is output by the determinator 132-22 as a classification result and then held in the estimation result holding unit 133.

As described above, when the determinator 132 solves the two-class determination problem, the determination process on data which is likely to be erroneously classified ends midstream, and a classification into a classification result having a broad age range is made. Thus, for example, a face whose age is not easily estimated can be estimated with little error.

### 4. Fourth Embodiment

The age estimating apparatuses according to the first to third embodiments estimate an age of a facial image H included in an image P which is a still image, display an estimation result, and then end the age estimation process. However, the age estimating apparatus may use the estimation result for other estimation. Specifically, the age estimating apparatus may estimate an age of a facial image H included in a moving image using the estimation result. In this regard, an age estimating apparatus that estimates an age of a facial image H included in a moving image will be described as a fourth embodiment. In the fourth embodiment, image processing involved in a determination or the like is executed in units of frames under the assumption that a moving image is configured of a plurality of frames. However, image processing need not necessarily be executed in units of frames and may be executed in units of fields or the like. In the following, an image which is a unit of image processing on a moving image such as a frame or a field is appropriately referred to as a unit image.

### [Configuration Example of Age Estimating Apparatus 151]

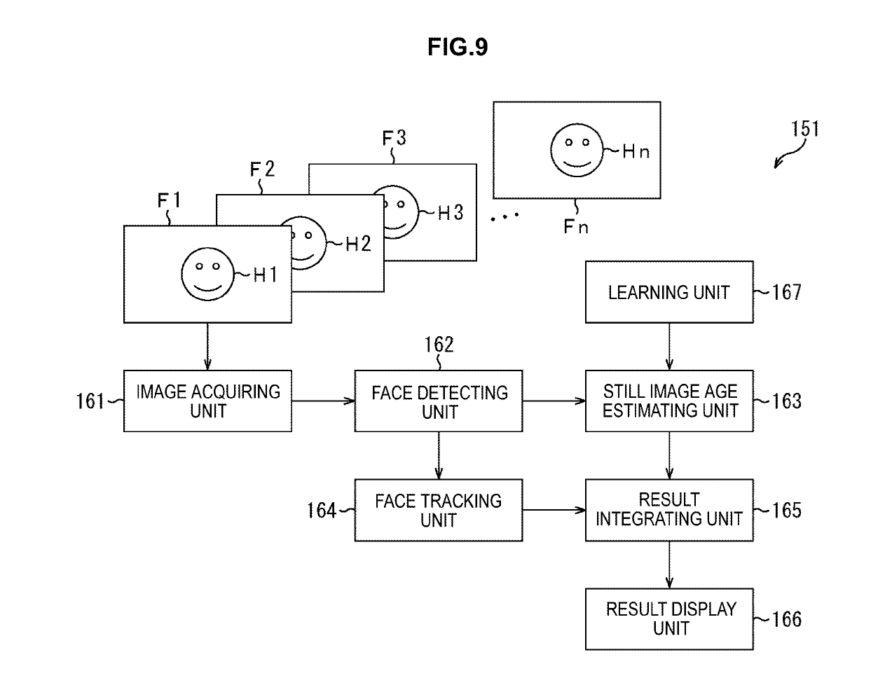

FIG. 9 is a block diagram illustrating a configuration of the age estimating apparatus 151.

The age estimating apparatus 151 includes an image acquiring unit 161, a face detecting unit 162, a still image age estimating unit 163, a face tracking unit 164, a result integrating unit 165, a result display unit 166, and a learning unit 167.

The image acquiring unit 161 is an apparatus capable of acquiring a moving image and acquires a moving image including a facial image H of a subject in units of unit images, that is, in units of frames. Specifically, the image acquiring unit 161 acquires frames F1 to Fn including facial images H1 to Hn (n is an integer value).

The face detecting unit 162 detects a facial image Hk included in a frame Fk from the whole area of the frame Fk (k is an arbitrary integer value ranging from 1 to n) acquired by the image acquiring unit 161. When a plurality of facial images Hk are included in the frame Fk, the face detecting unit 162 detects all of the facial images Hk.

The still image age estimating unit 163 extracts a feature quantity of a face from the facial image Hk of each frame Fk detected by the face detecting unit 162, and estimates an age of a person having the face based on the feature quantity of the face. When the face detecting unit 162 detects a plurality of facial images Hk in the frame Fk, the still image age estimating unit 163 performs age estimation on each facial image Hk. The still image age estimating unit 163 has basically the same function and configuration as the age estimating unit 13 of FIG. 1, and thus the redundant description will not be repeated. A determinator of a multi-stage determining unit included in the still image age estimating unit 163 may be a determinator to which two age ranges with a margin are assigned. The determinator may end a determination process midstream on data which is likely to be erroneously classified when solving a two-class determination problem.

The face tracking unit 164 sets a predetermined facial image Hk detected by the face detecting unit 162 as a tracking target, and then tracks the predetermined facial image Hk in subsequent frames. As a result, the predetermined facial image Hk tracked over a plurality of frames is regarded as a face of the same person.

### [Face Tracking]

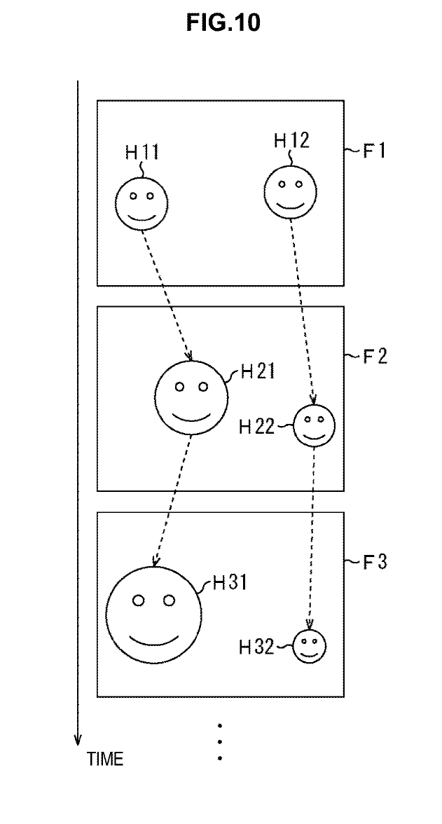

FIG. 10 is a diagram for explaining a tracking operation.

As illustrated in FIG. 10, a frame F1 includes a facial image H11 and a facial image H12 of two persons, a frame F2 includes a facial image H21 and a facial image H22, and a frame F3 includes a facial image H31 and a facial image H32.

In this case, through tracking of the face tracking unit 164, the facial images H11, H21, and H31 tracked over frames are regarded as the facial image H of the same person. Similarly, through tracking of the face tracking unit 164, the facial images H12, H22, and H32 tracked over frames are regarded as the facial image H of the same person. In other words, the face tracking unit 164 can specify a face of the same person included over frames. A tracking technique is not particularly limited, and for example, a general technique such as tracking based on an optical flow may be employed.

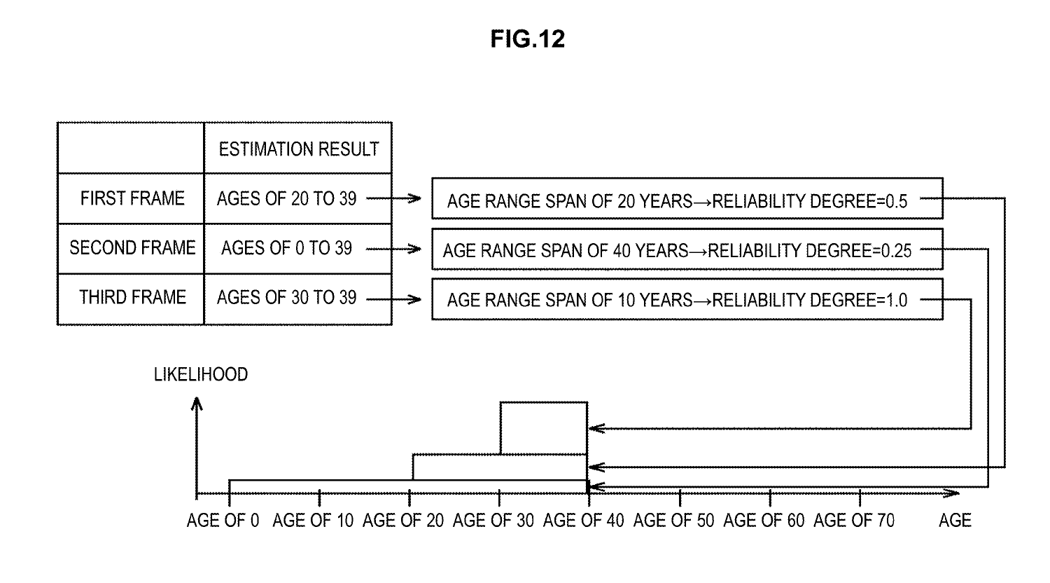

Returning to the description of FIG. 9, the result integrating unit 165 integrates age estimation results of the respective frames Fk by which the still image age estimating unit 163 has estimated on a predetermined person specified as the same person by the face tracking unit 164, and then outputs an age estimation result of the predetermined person in the moving image. In other words, the result integrating unit 165 integrates a plurality of estimation results obtained by the still image age estimating unit 163. The result integrating unit 165 may calculate an estimated age probability distribution on a predetermined person in a moving image together with the estimation result. An age estimation result integration by the result integrating unit 165 will be described later with reference to FIG. 12.

The learning unit 167 causes each determinator included in the still image age estimating unit 163 to perform learning The learning unit 167 basically has the same function and configuration as the learning unit 15 of FIG. 1, and the redundant description will not be repeated.

The result display unit 166 causes an age estimation result integrated by the result integrating unit 165 to be displayed on a display device or the like.

Next, a process (hereinafter referred to as an “age estimation process”) executed by the age estimating apparatus 151 will be described.

### [Age Estimation Process]

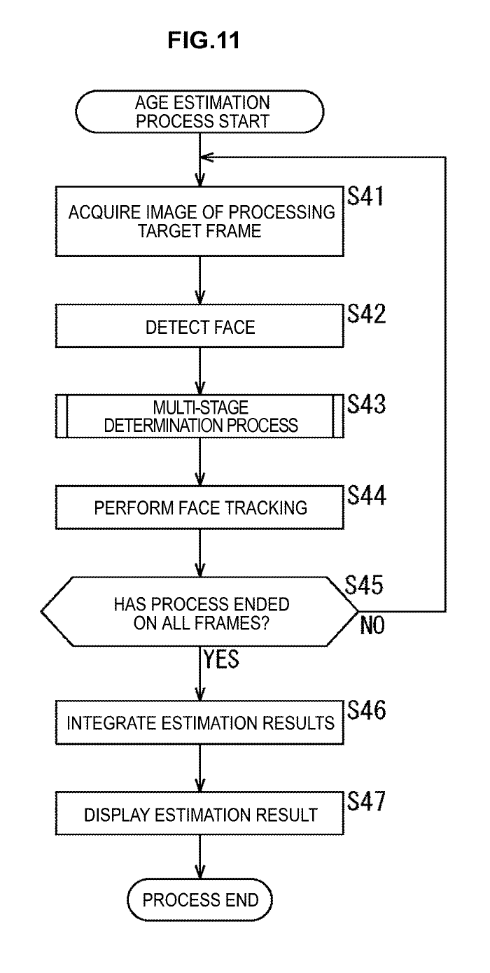

FIG. 11 is a flowchart to explain the flow of the age estimation process.

In step S41, the image acquiring unit 161 acquires an image of a processing target frame Fk including a facial image Hk of a subject.

In step S42, the face detecting unit 162 detects the facial image Hk from the processing target frame Fk including the facial image Hk of the subject acquired by the image acquiring unit 161.

In step S43, the still image age estimating unit 163 executes a multi-stage determination process. The multi-stage determination process is basically the same as in FIG. 4, and the redundant description will not be repeated.

In step S44, the face tracking unit 164 performs face tracking. In other words, the face tracking unit 164 specifies a face of the same person included over frames on the facial image Hk detected by the face detecting unit 162.

In step S45, the result integrating unit 165 determines whether or not the process has ended on all frames.

When the process has not yet ended on all frames, a determination result in step S45 is NO. Then, the process returns to step S41, and the process of step S41 and the subsequent processes are repeated. In other words, the processes of steps S41 to S45 are repeated until the process ends on all frames.

Thereafter, when the process has ended on all frames, a determination result in step S45 is YES, and the process proceeds to step S46.

In step S46, the result integrating unit 165 integrates estimation results. In other words, the result integrating unit 165 integrates age estimation results of the respective frames Fk by which the still image age estimating unit 163 has estimated on a predetermined person specified by the face tracking unit 164. As a result, an age estimation result of a predetermined person in a moving image is calculated. Further, the result integrating unit 165 calculates a probability that the age of the person will be classified into each of a plurality of previously set age ranges.

In step S47, the result display unit 166 displays the age estimation result integrated by the result integrating unit 165.

Then, the age estimation process ends.

Next, the age estimation result integration by the result integrating unit 165 will be described.

### [Estimation Result Integration]

FIG. 12 is a diagram for explaining estimation result integration.

An upper drawing of FIG. 12 illustrates age estimation results of the frames Fk by the still image age estimating unit 163 for a predetermined person specified by the face tracking unit 164. In the following, a description will be made using results of frames F1 to F3.

An age estimation result of a predetermined person in a first frame, that is, the frame F1, is assumed to have an age range span of 20 years such as “ages of 20 to 39.” An age estimation result of a predetermined person in a second frame, that is, the frame F2, is assumed to have an age range span of 40 years such as “ages of 0 to 39.” An age estimation result of a predetermined person in a third frame, that is, the frame F3, is assumed to have an age range span of 10 years such as “ages of 30 to 39.”

The result integrating unit 165 regards an age estimation result whose age range span is relatively large, among age estimation results in the frames F1 to F3 by the still image age estimating unit 163, as an ambiguous estimation result, and sets a low reliability degree to the ambiguous estimation result. Specifically, the reliability degree of the age estimation result is calculated by “reliability degree=10/age range span.”

Through the above formula, the reliability degree of the age estimation result in the frame F1 is calculated as 0.5. Further, the reliability degree of the age estimation result in the frame F2 is calculated as 0.25. Further, the reliability degree of the age estimation result in the frame F3 is calculated as 1.0.

Then, the reliability degree of the age estimation result calculated for each frame is added for each age as the likelihood, and so a probability distribution of each age is constructed as illustrated in a lower drawing of FIG. 12.

The lower drawing of FIG. 12 is a diagram for explaining an age probability distribution as an estimation result. In the lower drawing of FIG. 12, a vertical axis represents the likelihood of the reliability degree, and a horizontal axis represents an age.

The age estimation result of each frame is represented by a rectangle, and the height of the rectangle changes according to the reliability degree of the estimation result. Specifically, a rectangle representing “ages of 20 to 39,” which is the estimation result in the frame F1, has the height corresponding to the reliability degree 0.5. Further, a rectangle representing “ages of 0 to 39,” which is the estimation result in the frame F2, has the height corresponding to the reliability degree 0.25. Further, a rectangle representing “ages of 30 to 39,” which is the estimation result in the frame F3, has the height corresponding to the reliability degree 1.0.

The result integrating unit 165 regards the reliability degree of the estimation result of each frame as a probability distribution of a uniform distribution such as a rectangle, and integrates the reliability degree of the estimation result of each frame to calculate an estimated age probability distribution on a predetermined person in a moving image. A probability that an age of a predetermined person in a moving image will fall within a predetermined age range is calculated by a ratio of an area of a rectangle present in the predetermined age range to an area obtained by integrating all rectangles representing the reliability degree of the estimation result of each frame. Specifically, a probability that an age of a predetermined person in a moving image will fall within a range of “ages of 0 to 9” is calculated as 8%, a probability that an age of a predetermined person in a moving image will fall within a range of “ages of 10 to 19” is calculated as 8%, a probability that an age of a predetermined person in a moving image will fall within a range of “ages of 20 to 29” is calculated as 25%, and a probability that an age of a predetermined person in a moving image will fall within a range of “ages of 30 to 39” is calculated as 58%.

As described above, the result integrating unit 165 regards the reliability degree of the estimation result of each frame as a probability distribution of a uniform distribution on a person having a face included in each frame of a moving image, adds and integrates the reliability degree of the estimation result of each frame, and outputs a highly accurate probability distribution as an estimation result of the age of the person. In other words, the accuracy of age estimation can be improved by integrating a plurality of reliability degrees of age estimation results in still images such as frames.

### Other Embodiments

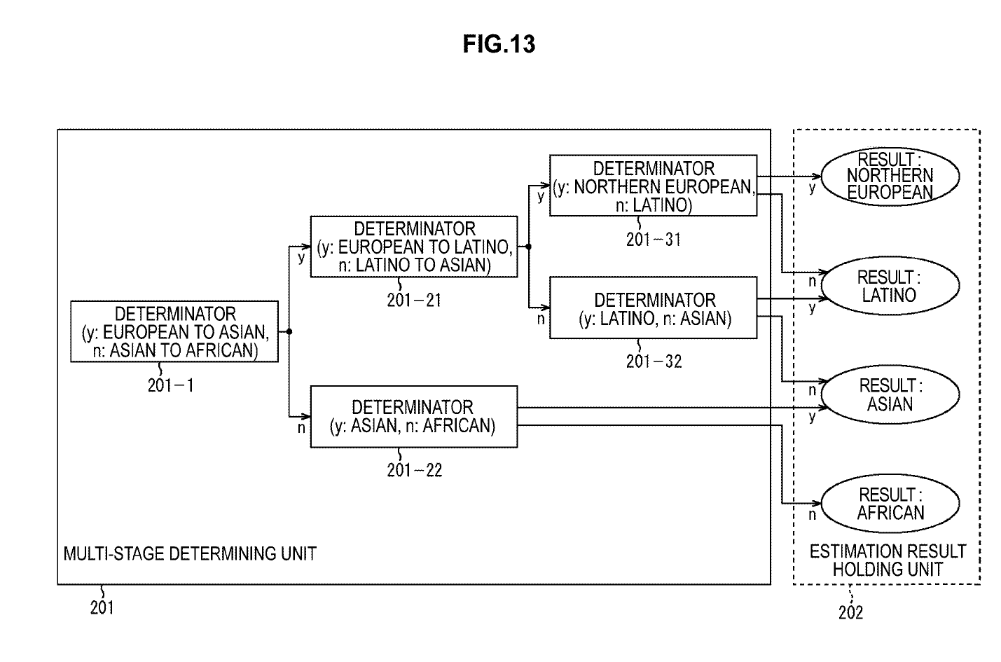

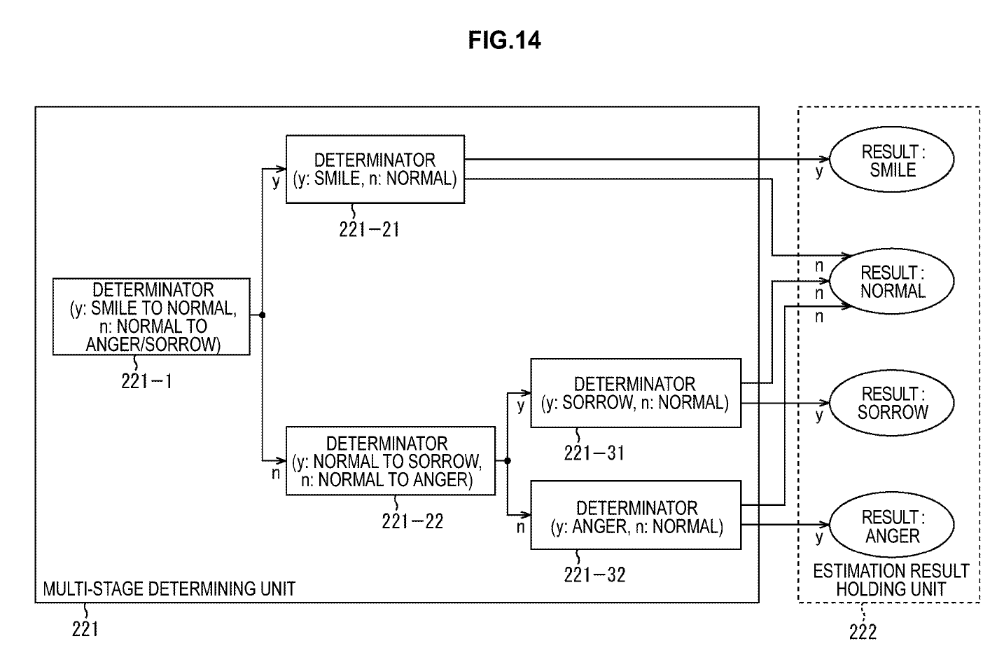

In the above embodiments, the multi-stage determining unit determines which of a plurality of previously set age ranges an age of a person is classified into based on a feature quantity of the face of the person in order to estimate an age of the person. However, the determination by the multi-stage determining unit is not limited to age estimation of a person but may be applied to other estimation such as estimation of a race or a facial expression. Next, race estimation and facial expression estimation will be individually described in order with reference to FIGS. 13 and 14, respectively.

### [Race Estimation]

FIG. 13 is a diagram illustrating a configuration example of a multi-stage determining unit 201 using race as a determination target.

The multi-stage determining unit 201 determines which of a plurality of previously set races a person having a corresponding face is classified into based on a feature quantity of the face extracted by a face feature quantity extracting unit (not shown).

As illustrated in FIG. 13, the multi-stage determining unit 201 is configured with nodes of a three-level tree structure such as a first-stage determinator 201-1, second-stage determinators 201-21 and 201-22, and third-stage determinators 201-31 and 201-32. In the following, when it is unnecessary to distinguish the determinators from one another, the determinators are collectively referred to as a determinator 201.

Each determinator 201 solves the two-class determination problem. In other words, in the present embodiment, two different races or two difference race ranges are assigned to each determinator 201 as two classes. Thus, each determinator 201 determines which of two races or two race ranges a person having a corresponding face is classified into based on an input feature quantity of the face.

Specifically, a first race range “European to Asian” and a second race range “Asian to African” are assigned to the first-stage determinator 201-1 as two classes. Thus, the first-stage determinator 201-1 determines which of the first and second race ranges a person having a corresponding face is classified into based on a feature quantity of the face extracted by a face feature quantity extracting unit (not shown). Here, the Asian race has a feature quantity between the European race and the African race, and two race ranges having a margin of “Asian,” that is, race ranges of “European” and “African,” are assigned to the first-stage determinator 201-1. As a result, the first-stage determinator 201-1 can perform a determination by which a more correct classification result can be obtained.

When the first-stage determinator 201-1 classifies the person having the corresponding face into the first race range “European to Asian” based on a feature quantity of the face extracted by a face feature quantity extracting unit (not shown), the feature quantity of the face is supplied to the second-stage determinator 201-21 together with the classification result. However, when the first-stage determinator 201-1 classifies the person having the corresponding face into the second race range “Asian to African” based on a feature quantity of the face extracted by a face feature quantity extracting unit (not shown), the feature quantity of the face is supplied to the second-stage determinator 201-22 together with the classification result.

A first race range “Northern European to Latino” and a second race range “Latino to Asian” are assigned to the second-stage determinator 201-21 as two classes. Thus, the second-stage determinator 201-21 determines which of the first and second race ranges a person having a corresponding face is classified into based on the feature quantity of the face input by the first-stage determinator 201-1. The Latino race has a feature quantity between the northern European race and the Asian race, and two race ranges having a margin of “Latino,” that is, race ranges of “Northern European” and “Asian,” are assigned to the second-stage determinator 201-21. As a result, the second-stage determinator 201-21 can perform a determination by which a more correct classification result can be obtained.

When the second-stage determinator 201-21 classifies the person having the corresponding face into the first race range “Northern European to Latino” based on the feature quantity of the face input by the first-stage determinator 201-1, the feature quantity of the face is supplied to the third-stage determinator 201-31 together with the classification result. However, when the second-stage determinator 201-21 classifies the person having the corresponding face into the second race range “Latino to Asian” based on the feature quantity of the face input by the first-stage determinator 201-1, the feature quantity of the face is supplied to the third-stage determinator 201-32 together with the classification result.

Further, a first race “Asian” and a second race “African” are assigned to the second-stage determinator 201-22 as two classes. Thus, the second-stage determinator 201-22 determines which of the first and second races a person having a corresponding face is classified into based on the feature quantity of the face input by the first-stage determinator 201-1.

When the second-stage determinator 201-22 classifies the person having the corresponding face into the first race “Asian” based on the feature quantity of the face input by the first-stage determinator 201-1, “Asian,” which is the classification result, is supplied to the estimation result holding unit 202. However, when the second-stage determinator 201-22 classifies the person having the corresponding face into the second race “African” based on the feature quantity of the face input by the first-stage determinator 201-1, “African,” which is the classification result, is supplied to the estimation result holding unit 202.

A first race “northern European” and a second race “Latino” are assigned to the third-stage determinator 201-31 as two classes. Thus, the third-stage determinator 201-31 determines which of the first and second races a person having a corresponding face is classified into based on the feature quantity of the face input by the second-stage determinator 201-21.

When the third-stage determinator 201-31 classifies the person having the corresponding face into the first race “Northern European” based on the feature quantity of the face input by the second-stage determinator 201-21, “Northern European,” which is the classification result, is supplied to the estimation result holding unit 202. However, when the third-stage determinator 201-31 classifies the person having the corresponding face into the second race “Latino” based on the feature quantity of the face input by the second-stage determinator 201-21, “Latino,” which is the classification result, is supplied to the estimation result holding unit 202.

Further, a first race “Latino” and a second race “Asian” are assigned to the third-stage determinator 201-32 as two classes. Thus, the third-stage determinator 201-32 determines which of the first and second races a person having a corresponding face is classified into based on the feature quantity of the face input by the second-stage determinator 201-21.

When the third-stage determinator 201-32 classifies the person having the corresponding face into the first race “Latino” based on the feature quantity of the face input by the second-stage determinator 201-21, “Latino,” which is the classification result, is supplied to the estimation result holding unit 202. However, when the third-stage determinator 201-32 classifies the person having the corresponding face into the second race “Asian” based on the feature quantity of the face input by the second-stage determinator 201-21, “Asian,” which is the classification result, is supplied to the estimation result holding unit 202.

Further, for example, when a person of a classification target is a mixed-race person of two or more races or when a person of a classification target resides in a region (an ambiguous region) in which it is difficult to clearly single out a prevalent race, the determination process ends midstream, and classification into a classification result having a broad race range is made.

### [Facial Expression Estimation]

FIG. 14 is a diagram illustrating a configuration example of a multi-stage determining unit 221 using a facial expression as a determination target.

The multi-stage determining unit 221 determines which of a plurality of previously set facial expressions a facial expression of a person having a corresponding face is classified into based on a feature quantity of the face extracted by a face feature quantity extracting unit (not shown).

As illustrated in FIG. 14, the multi-stage determining unit 221 is configured with nodes of a three-level tree structure such as a first-stage determinator 221-1, second-stage determinators 221-21 and 221-22, and third-stage determinators 221-31 and 221-32. In the following, when it is unnecessary to distinguish the determinators from one another, the determinators are collectively referred to as a determinator 221.

Each determinator 221 solves the two-class determination problem. In other words, in the present embodiment, two different facial expressions or two different facial expression ranges are assigned to each determinator 221 as two classes. Thus, each determinator 221 determines which of two facial expressions or two facial expression ranges a person having a corresponding face is classified into based on an input feature quantity of the face.

Specifically, a first facial expression range “smile to normal” and a second facial expression range “normal to anger/sorrow” are assigned to the first-stage determinator 221-1 as two classes. Thus, the first-stage determinator 221-1 determines which of the first and second facial expression ranges a person having a corresponding face is classified into based on a feature quantity of the face extracted by a face feature quantity extracting unit (not shown). Here, the facial expression “normal” has a feature quantity between the facial expression “smile” and the facial expression “anger and sorrow,” two facial expression ranges having a margin of “normal,” that is, expression ranges of “smile” and “anger/sorrow” are assigned to the first-stage determinator 221-1. As a result, the first-stage determinator 221-1 can perform a determination by which a more correct classification result can be obtained.

When the first-stage determinator 221-1 classifies a person having a corresponding face into the first facial expression range “smile to normal” based on a feature quantity of the face extracted by a face feature quantity extracting unit (not shown), the feature quantity of the face is supplied to the second-stage determinator 221-21 together with the classification result. When the first-stage determinator 221-classifies a person having a corresponding face into the second facial expression range “normal to anger/sorrow” based on a feature quantity of the face extracted by a face feature quantity extracting unit (not shown), the feature quantity of the face is supplied to the second-stage determinator 221-22 together with the classification result.

A first facial expression range “smile” and a second facial expression range “normal” are assigned to the second-stage determinator 221-21 as two classes. Thus, the second-stage determinator 221-21 determines which of the first and second facial expressions a person having a corresponding face is classified into based on the feature quantity of the face input by the first-stage determinator 221-1.

When the second-stage determinator 221-21 classifies the person having the corresponding face into the first facial expression “smile” based on the feature quantity of the face input by the first-stage determinator 221-1, “smile,” which is the classification result, is supplied to the estimation result holding unit 222. However, when the second-stage determinator 221-21 classifies the person having the corresponding face into the second facial expression “normal” based on the feature quantity of the face input by the first-stage determinator 221-1, “normal,” which is the classification result, is supplied to the estimation result holding unit 222.

Further, a first facial expression range “normal to sorrow” and a second facial expression range “normal to anger” are assigned to the second-stage determinator 221-22 as two classes. Thus, the second-stage determinator 221-22 determines which of the first and second facial expression ranges a person having a corresponding face is classified into based on the feature quantity of the face input by the first-stage determinator 221-1.

When the second-stage determinator 221-22 classifies a person having a corresponding face into the first facial expression range “normal to sorrow” based on the feature quantity of the face input by the first-stage determinator 221-1, the feature quantity of the face is supplied to the third-stage determinator 221-31 together with the classification result. However, when the second-stage determinator 221-22 classifies a person having a corresponding face into the second facial expression range “normal to anger” based on the feature quantity of the face input by the first-stage determinator 221-1, the feature quantity of the face is supplied to the third-stage determinator 221-32 together with the classification result.

A first facial expression range “sorrow” and a second facial expression range “normal” are assigned to the third-stage determinator 221-31 as two classes. Thus, the third-stage determinator 221-31 determines which of the first and second facial expressions a person having a corresponding face is classified into based on the feature quantity of the face input by the second-stage determinator 221-22.

When the third-stage determinator 221-31 classifies the person having the corresponding face into the first facial expression “sorrow” based on the feature quantity of the face input by the second-stage determinator 221-22, “sorrow,” which is the classification result, is supplied to the estimation result holding unit 222. However, when the third-stage determinator 221-31 classifies the person having the corresponding face into the second facial expression “normal” based on the feature quantity of the face input by the second-stage determinator 221-22, “normal,” which is the classification result, is supplied to the estimation result holding unit 222.

Further, a first facial expression range “anger” and a second facial expression range “normal” are assigned to the third-stage determinator 221-32 as two classes. Thus, the third-stage determinator 221-32 determines which of the first and second facial expression ranges a person having a corresponding face is classified into based on the feature quantity of the face input by the second-stage determinator 221-22.

When the third-stage determinator 221-32 classifies a person having a corresponding face into the first facial expression range “anger” based on the feature quantity of the face input by the second-stage determinator 221-22, “anger,” which is the classification result, is supplied to the estimation result holding unit 222. However, when the third-stage determinator 221-32 classifies a person having a corresponding face into the second facial expression range “normal” based on the feature quantity of the face input by the second-stage determinator 221-22, “normal,” which is the classification result, is supplied to the estimation result holding unit 222.

Further, for example, when it is difficult for the determinator 221-21 to classify a facial expression of a processing target into any of “smile” and “normal,” a classification result may be regarded as an “ambiguous expression,” and so the determination process may end midstream.

### [Classification of Genre of Book]

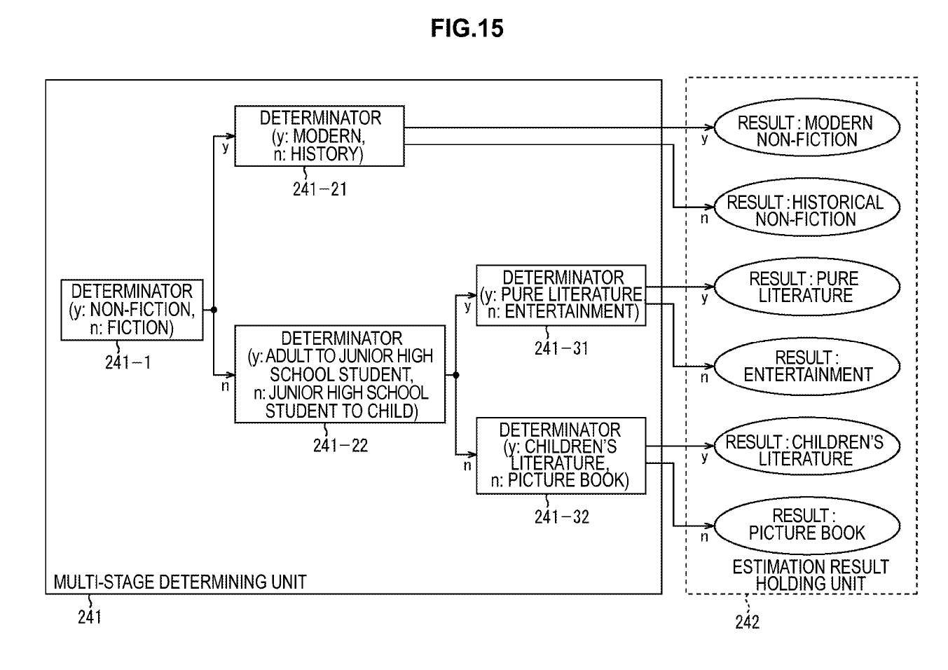

Further, a plurality of processing targets may be processed by the multi-stage determining unit. In addition, a determination target of classification or a category of classification by the multi-stage determining unit is not particularly limited to the above examples but may be arbitrary. For example, books or music may be set as a determination target, and a genre of a classification target may be set as a category of classification. A classification of a genre of a book will be described with reference to FIG. 15 as a concrete example.

FIG. 15 is a diagram illustrating a configuration example of a multi-stage determining unit 241 in which a book is set as a determination target of classification and a genre of a book is set as a category of classification.

The multi-stage determining unit 241 determines which of a plurality of previously set book genres a book having a corresponding feature quantity is classified into based on the feature quantity of the book extracted by the feature quantity extracting unit (not shown).

As illustrated in FIG. 15, the multi-stage determining unit 241 is configured with nodes of a three-level tree structure such as a first-stage determinator 241-1, second-stage determinators 241-21 and 241-22, and third-stage determinators 241-31 and 241-32. Further, when it is unnecessary to distinguish the determinators from one another, the determinators are referred to as a determinator 241.

Each determinator 241 solves the two-class determination problem. In other words, in the present embodiment, two different book genres or two different genre ranges are assigned to each determinator 241 as two classes. Thus, each determinator 241 determines which one of two book genres or two genre ranges a genre of a corresponding book is classified into based on an input feature quantity of the book.

Specifically, a first book genre “non-fiction” and a second book genre “fiction” are assigned to the first-stage determinator 241-1 as two classes. Thus, the first-stage determinator 241-1 determines which of the first and second book genres a genre of a corresponding book is classified into based on the feature quantity of the book extracted by the feature quantity extracting unit (not shown).

When the first-stage determinator 241-1 classifies the corresponding book into the first book genre “non-fiction” based on the feature quantity of the book extracted by the feature quantity extracting unit (not shown), the feature quantity of the book is supplied to the second-stage determinator 241-21 together with the classification result. However, when the first-stage determinator 241-1 classifies the corresponding book into the second book genre “fiction” based on the feature quantity of the book extracted by the feature quantity extracting unit (not shown), the feature quantity of the book is supplied to the second-stage determinator 241-22 together with the classification result.

A first book genre “modern” and a second book genre “history” are assigned to the second-stage determinator 241-21 as two classes. Thus, the second-stage determinator 241-21 determines which of the first and second book genres the corresponding book is classified into based on the feature quantity of the book input by the first-stage determinator 241-1.

When the second-stage determinator 241-21 classifies the corresponding book into the first book genre “modern” based on the feature quantity of the book input by the first-stage determinator 241-1, “modern,” which is the classification result, is supplied to an estimation result holding unit 242 and then held as an estimation result such as “modern non-fiction.” However, when the second-stage determinator 241-21 classifies the corresponding book into the second book genre “history,” based on the feature quantity of the book input by the first-stage determinator 241-1, “history,” which is the classification result, is supplied to the estimation result holding unit 242 and then held as an estimation result such as “historical non-fiction.”

Here, each genre of a book can be classified according to a target age, and a classified target age can be regarded as a large genre of a genre of an upper layer of each genre of a book. To this end, a first large genre range “adult to junior high school student” and a second large genre range “junior high school student to child” are assigned to the second-stage determinator 241-22 as classes. Thus, the second-stage determinator 241-22 classifies which of the first and second large genre ranges a corresponding book is classified into based on the feature quantity of the book input by the first-stage determinator 241-1. Here, two large book genre ranges having a margin of “junior high school student” as a target age of a book are assigned to the second-stage determinator 241-22. In other words, an age interposed between two ages may be set as a target age of a corresponding book. As a result, the second-stage determinator 241-22 can perform a determination by which a more correct classification result can be obtained.

When the second-stage determinator 241-22 classifies the corresponding book into the first large genre range “adult to junior high school student” based on the feature quantity of the book input by the first-stage determinator 241-1, the feature quantity of the book is supplied to the third-stage determinator 241-31 together with the classification result. However, when the second-stage determinator 241-22 classifies the corresponding book into the second large genre range “junior high school student to child” based on the feature quantity of the book input by the first-stage determinator 241-1, the feature quantity of the book is supplied to the third-stage determinator 241-32 together with the classification result.

A first book genre “pure literature” and a second book genre “entertainment” are assigned to the third-stage determinator 241-31 as two classes. Thus, the third-stage determinator 241-31 determines which of the first and second book genres a corresponding book is classified into based on the feature quantity of the book input by the second-stage determinator 241-22.

When the third-stage determinator 241-31 classifies the corresponding book into the first book genre “pure literature” based on the feature quantity of the book input by the second-stage determinator 241-22, “pure literature,” which is the classification result, is supplied to the estimation result holding unit 242. However, when the third-stage determinator 241-31 classifies the corresponding book into the second book genre “entertainment” based on the feature quantity of the book input by the second-stage determinator 241-22, “entertainment,” which is the classification result, is supplied to the estimation result holding unit 242.

Further, a first book genre “children's literature” and a second book genre “picture book” are assigned to the third-stage determinator 241-32 as two classes. Thus, the third-stage determinator 241-32 determines which of the first and second book genre ranges a corresponding book is classified into based on the feature quantity of the book input by the second-stage determinator 241-22.

When the third-stage determinator 241-32 classifies the corresponding book into the first book genre “children's literature” based on the feature quantity of the book input by the second-stage determinator 241-22, “children's literature,” which is the classification result, is supplied to the estimation result holding unit 222. However, when the third-stage determinator 241-32 classifies the corresponding book into the second book genre “picture book” based on the feature quantity of the book input by the second-stage determinator 241-22, “picture book,” which is the classification result, is supplied to the estimation result holding unit 222.

Further, for example, when it is difficult for the determinator 241-31 to classify a genre of a book into any of “pure literature” and “entertainment,” the determination process may end midstream.

As described above, the purpose of a classification determination by the multi-stage determining unit is not limited to the purpose of age estimation of a person but may be used for various purposes. Particularly, a correct classification result can be obtained on a classification target which is likely to obtain an ambiguous classification result.

### [Multi-Stage Determining Unit Including Determinators of Two or More Types]

In the above examples, for example, the multi-stage determining unit includes only the determinator for determining an age when estimating an age of a predetermined person. However, when an age of a predetermined person is estimated, the multi-stage determining unit may include the determinator for determining race. In other words, the multi-stage determining unit may be configured to include determinators for determining determination targets of different types.

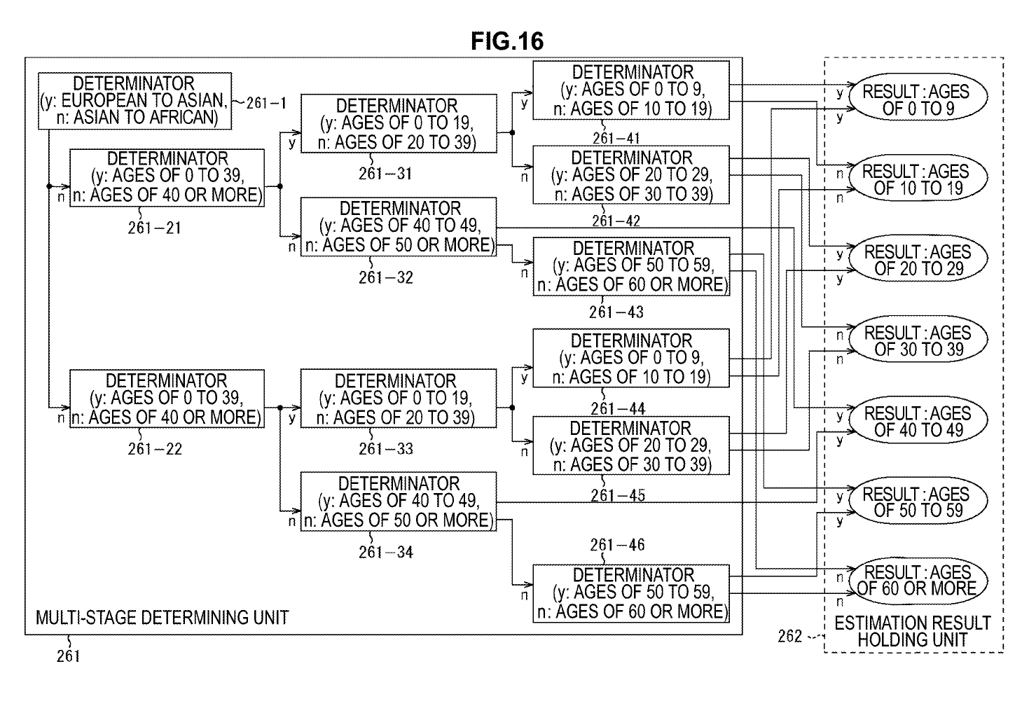

FIG. 16 is a diagram for explaining a multi-stage determining unit 261 configured to include determinators for determining determination targets of different types, respectively.

The multi-stage determining unit 261 determines which of a plurality of previously set age ranges an age of a person having a corresponding face is classified into based on a feature quantity of the face extracted by a face feature quantity extracting unit (not shown).

As illustrated in FIG. 16, the multi-stage determining unit 261 is configured with nodes of a four-level tree structure such as a first-stage determinator 261-1 for determining race, and second-stage determinators 261-21 and 261-22, third-stage determinators 261-31 to 261-34, and fourth-stage determinators 261-41 to 261-46, which are used to determine age. In the following, when it is unnecessary to distinguishing the determinators from one another, the determinators are collectively referred to as a determinator 261.

As described above, when an age of a predetermined person is estimated, the multi-stage determining unit 261 first determines a race of the person through the first-stage determinator 261-1. Thus, a determination by which a more correct classification result can be obtained can be performed even when a feature quantity is the same but a different age is estimated according to race.

In this case, two race ranges having a margin of “Asian” may be assigned to the first-stage determinator 261-1 so that correct age estimation can be performed even when the Asian race is classified into any of the determinators 261-21 and 261-22 of the next stage that determine age.

### [Another Example of Estimation Result Integration]

In the example of FIG. 12, the result integrating unit 165 integrates a reliability degree of a uniform distribution of each frame when integrating age estimation results. However, a technique of integrating age estimation results of frames by the result integrating unit 165 is not limited to the above example, and, for example, a technique using the Gaussian distribution may be employed.

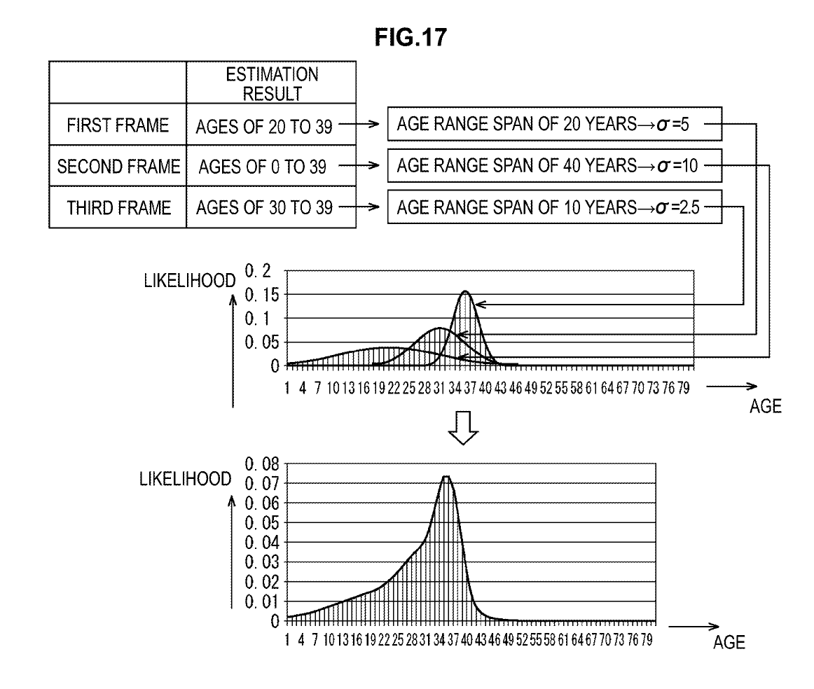

FIG. 17 is a diagram for explaining another example of estimation result integration.

An upper drawing of FIG. 17 illustrates an age estimation result of each frame Fk which the still image age estimating unit 163 has obtained on a predetermined person. The following description will be made in connection with estimation results of frames F1 to F3.

An age estimation result of a predetermined person in a first frame, that is, the frame F1, is assumed to have an age range span of 20 years such as “ages of 20 to 39.” An age estimation result of a predetermined person in a second frame, that is, the frame F2, is assumed to have an age range span of years such as “ages of 0 to 39.” Further, an age estimation result of a predetermined person in a third frame, that is, the frame F3, is assumed to have an age range span of 10 years such as “ages of 30 to 39.”

The result integrating unit 165 may use a reliability degree of the Gaussian distribution as an age estimation result in each frame F. For example, in the Gaussian distribution, a central value of an age range span is used as an average of the distribution, and a value calculated based on the age range span is given as a standard deviation σ. Specifically, in the example of FIG. 17, for example, the standard deviation σ is calculated as “standard deviation σ=age range span/4.”

Through the above formula, the standard deviation σ in the frame F1 is calculated as 5. Further, the standard deviation σ in the frame F2 is calculated as 10. Further, the standard deviation σ in the frame F3 is calculated as 2.5.

A second drawing of FIG. 17 is a diagram for explaining the Gaussian distribution of age as an estimation result. In the second drawing of FIG. 17, a vertical axis represents likelihood, and a horizontal axis represents age.

As illustrated in the second drawing of FIG. 17, the Gaussian distribution of the frame F1 is represented by a curve having an age of about 30 as a central value of the age range span. Further, the Gaussian distribution of the frame F2 is represented by a curve having an age of about 20 as a central value of the age range span. Further, the standard deviation σ of the frame F3 is represented by a curve having an age of about 35 as a central value of the age range span. As described above, as the age range span increases, that is, as the standard deviation σ increases, the span of the Gaussian distribution increases.

When all of the Gaussian distributions of the frames F1 to F3 are added according to an age, a probability distribution illustrated in a lower drawing of FIG. 17 is obtained. In this way, an estimated age of a predetermined person in a moving image can be obtained as the probability distribution. In other words, a probability calculated by a ratio of an area within a predetermined age range to an area within the curve of the probability distribution is obtained as a result of an estimated age of a predetermined person. Specifically, a probability that an age of a predetermined person in a moving image will fall within a range of “ages of 0 to 9” is calculated as 4%, a probability that an age of a predetermined person in a moving image will fall within a range of “ages of 10 to 19” is calculated as 12%, a probability that an age of a predetermined person in a moving image will fall within a range of “ages of 20 to 29” is calculated as 27%, a probability that an age of a predetermined person in a moving image will fall within a range of “ages of 30 to 39” is calculated as 54%, and a probability that an age of a predetermined person in a moving image will fall within a range of “ages of 40 to 49” is calculated as 3%.

A probability that an age of a predetermined person in a moving image will be classified into a range other than a previously set age range, for example, a range of “ages of 32 to 37,” can be calculated using the Gaussian distribution. Further, a probability that an age of a predetermined person in a moving image will be classified into an age range such as “ages of 35±2” can be calculated.

### [Other Example of Estimation Result Integration]

In the examples of FIGS. 12 and 17, the result integrating unit 165 employs the technique of estimating an age by integrating final estimation results of frames. However, the technique of integrating the age estimation results by the result integrating unit 165 is not limited to the above examples. For example, estimation results may be integrated based on paths of the determinators used by the multi-stage determining unit among the determinators configuring the tree structure.

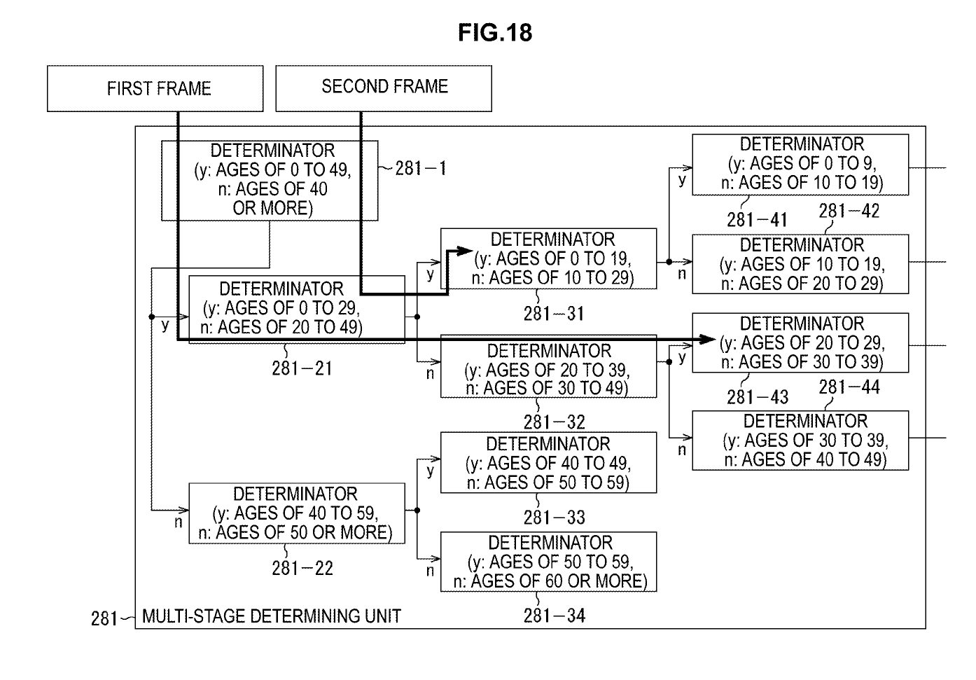

FIG. 18 is a diagram illustrating paths of determinators used by a multi-stage determining unit 281.

The multi-stage determining unit 281 is configured with nodes of a four-level tree structure such as a first-stage determinator 281-1, second-stage determinators 281-21 and 281-22, third-stage determinators 281-31 to 281-34, and fourth-stage determinators 281-41 to 281-44. In the following, when it is unnecessary to distinguish the determinators from one another, the determinators are collectively referred to as a determinator 281.

When age estimation is performed on a moving image, the multi-stage determining unit 281 estimates an age of a person having a corresponding face based on a feature quantity of the face in units of frames. In order to output an age estimation result of a predetermined person in a first frame, that is, a frame F1, the multi-stage determining unit 281 causes the determinators to execute a determination according to a path of the determinators 281-1, 281-21, 281-32, and 281-43. Further, in order to output an age estimation result of a predetermined person in a second frame, that is, a frame F2, the multi-stage determining unit 281 causes the determinators to execute a determination according to a path of the determinators 281-1, 281-21, and 281-31. In FIG. 18, a description is made using estimation results up to the second frame.

In this case, for example, a determination in the determinator 281-1 is executed in an age range of “ages of 0 to 70” obtained as a result of adding a first age range “ages of 0 to 49” and a second age range “ages of 40 or more.” Here, an age of 70 is set as an upper age limit. Thus, at a point in time when a determination in the determinator 281-1 is made, an age of a predetermined person of a processing target is classified into the age range of “ages of 0 to 70” obtained by adding at least the two age ranges.

Further, for example, a determination in the determinator 281-21 is executed in an age range of “ages of 0 to 49” obtained as a result of adding a first age range “ages of 0 to 29” and a second age range “ages of 20 to 49.” Thus, at a point in time when a determination in the determinator 281-21 is made, an age of a predetermined person of a processing target is classified into an age range of “ages of 0 to 49” obtained by adding at least the two age ranges. Similarly, at a point in time when a determination in the determinator 281-31 is made, an age of a predetermined person of a processing target is classified into an age range of “ages of 0 to 29.” At a point in time when a determination in the determinator 281-32 is made, an age of a predetermined person of a processing target is classified into an age range of “ages of 20 to 49.” Further, at a point in time when a determination in the determinator 281-43 is made, an age of a predetermined person of a processing target is classified into an age range of “ages of 20 to 39.”

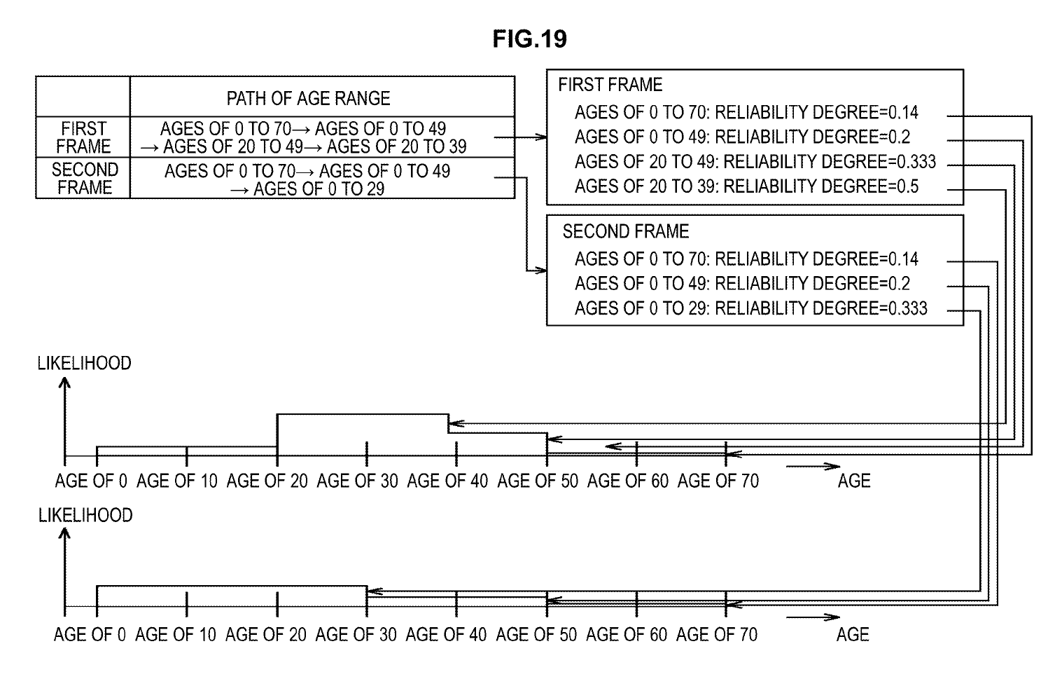

FIG. 19 is a diagram for explaining another example of estimation result integration.

As illustrated in an upper drawing of FIG. 19, when age estimation of a person in the frame F1 is executed according to the above-described path, an age estimation result at a point in time when a determination is made by each determinator 281 is classified into each age range in the order of “ages of 0 to 70,” “ages of 0 to 49,” “ages of 20 to 49,” and “ages of 20 to 39.” Further, when age estimation of a person in the frame F2 is executed according to the above-described path, an age estimation result at a point in time when a determination is made by each determinator 281 is classified into each age range in the order of “ages of 0 to 70,” “ages of 0 to 49,” and “ages of 0 to 29.”

Similarly to the example of FIG. 12, the result integrating unit 165 calculates a reliability degree of an estimation result in each determinator 281 traced by the multi-stage determining unit 281 based on “reliability degree=10/age range span” in units of frames Fk.

First, when a reliability degree of an estimation result by each determinator 281 in the frame F1 is calculated, since an age range span of the estimation result in the determinator 281-1 is 71 years, the reliability degree is calculated as 0.14 by the above formula. Further, since an age range span of the estimation result in the determinator 281-21 is 50 years, the reliability degree is calculated as 0.2 by the above formula. Further, since an age range span of the estimation result in the determinator 281-32 is 30 years, the reliability degree is calculated as 0.333 by the above formula. Further, since an age range span of the estimation result in the determinator 281-43 is 20 years, the reliability degree is calculated as 0.5 by the above formula.

First, when a reliability degree of an estimation result by each determinator 281 in the frame F2 is calculated, since an age range span of the estimation result in the determinator 281-1 is 71 years, the reliability degree is calculated as 0.14 by the above formula. Further, since an age range span of the estimation result in the determinator 281-21 is 50 years, the reliability degree is calculated as 0.2 by the above formula. Further, since an age range span of the estimation result in the determinator 281-31 is 30 years, the reliability degree is calculated as 0.333 by the above formula. Further, it can be understood that each time a determination by each determinator 281 is executed, the reliability degree of the estimation result increases.

The reliability degrees of the estimation results calculated in units of frames as described above are used as a likelihood of a probability distribution illustrated in a second drawing and a lower drawing of FIG. 19 and added.

The second drawing of FIG. 19 illustrates the probability distribution of the estimation result of the frame F1, and the lower drawing of FIG. 19 illustrates the probability distribution of the estimation result of the frame F2. In the second drawing and the lower drawing of FIG. 19, a vertical axis represents likelihood, and a horizontal axis represents age.

The result integrating unit 165 can calculate a probability distribution of an estimated age of a predetermined person having a face included in a moving image by adding probability distributions of estimation results of all frames included in a moving image, for example, by adding the probability distributions of the estimation results of the frames F1 and F2 illustrated in the second drawing and the lower drawing of FIG. 19.

In this way, the result integrating unit 165 obtains the reliability distribution of the estimation result in units of frames, based on the paths of the determinator used by the multi-stage determining unit, on a person having a face included in each frame of a moving image, and then adds and integrates the reliability distributions of the frames. As a result, the result integrating unit 165 can output the probability distribution with high accuracy as an estimation result of an age of a corresponding person.

### [Another Configuration Example of Determinator]

In the above examples, two age ranges or an age range margin assigned to the determinator included in the multi-stage determining unit have spans composed of 10-year units such as “ages of 0 to 19” and “ages of 20 to 49.” However, two age ranges or an age range margin assigned to each determinator are not limited to the above examples, and an age range of an arbitrary span may be assigned. Further, an estimation result held in the estimation result holding unit may be assigned an age range of an arbitrary span.

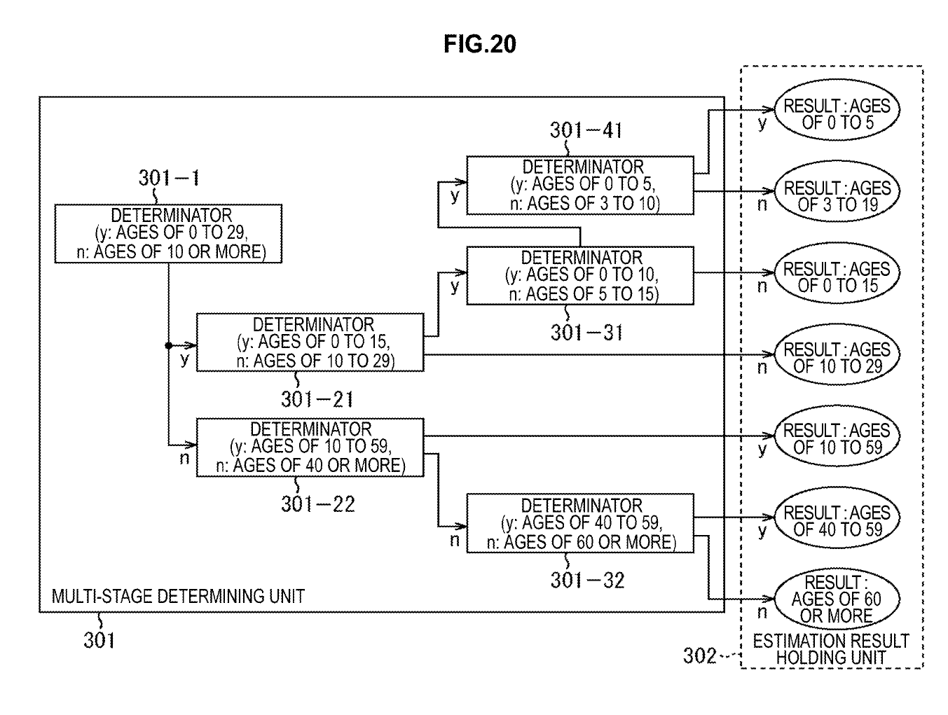

FIG. 20 is a diagram illustrating a configuration example of a multi-stage determining unit 301.

As illustrated in FIG. 20, the multi-stage determining unit 301 is configured with nodes of a four-level tree structure such as a first-stage determinator 301-1, second-stage determinators 301-21 and 301-22, third-stage determinators 301-31 and 301-32, and a fourth-stage determinator 302-41. In the following, when it is unnecessary to distinguish the determinators from one another, the determinators are collectively referred to as a determinator 301.

Two different age ranges are assigned to each determinator 301 as two classes.

A first age range “ages of 0 to 29” and a second age range “ages of 10 or more” are assigned to the determinator 301-1 as two classes. In other words, an age range having a span composed of 10-year units is assigned to the determinator 301-1.

On the other hand, a first age range “ages of 0 to 15” and a second age range “ages of 10 to 29” are assigned to the determinator 301-21 as two classes. In other words, a span of 16 years is assigned to the first age range, and a span of 20 years is assigned to the second age range. As described above, an age range span assigned to the determinator 301 need not necessarily be a span composed of 10-year units and may be an age range of an arbitrary span.

Further, a first age range “ages of 0 to 5” and a second age range “ages of 3 to 10” are assigned to the determinator 301-41 as two classes.

In other words, two age ranges having a margin of a range of “ages of 3 to 5,” that is, two age ranges having a margin of a span of 2 years are assigned to the determinator 301-41. As described above, an age range span assigned to the determinator 301 need not necessarily be a span composed of 10-year units and may be an age range of an arbitrary span.

Further, as illustrated in FIG. 20, an estimation result held in an estimation result holding unit 302 may also be assigned an age range of an arbitrary span so that “ages of 0 to 5” and “ages of 3 to 19” can be included as the estimation result held in the estimation result holding unit 302.

For example, by setting an age range of a small span to an age (for example, ages of 0 to 3) at which a feature quantity of a face remarkably changes and setting an age range of a large span to other ages, age estimation in a finer age range can be performed.

### [Another Configuration Example of Multi-Stage Determining Unit]

In the above examples, the determinator included in the multi-stage determining unit executes a determination based on a feature quantity of the face extracted by a single face feature quantity extracting unit. In other words, all of the determinators included in the multi-stage determining unit execute a determination based on the same feature quantity. However, the feature quantity of the determination target by the determinator is not limited to the above examples, and, for example, the determinators may use different feature quantities as determination targets.

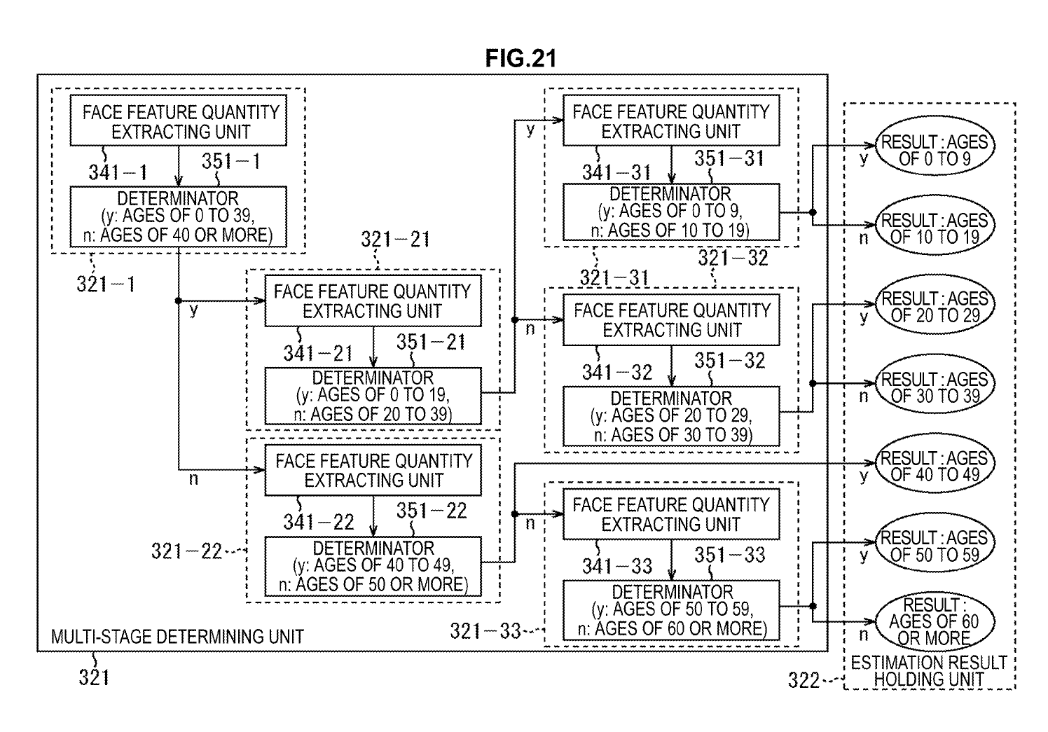

FIG. 21 is a diagram illustrating a configuration example of a multi-stage determining unit 321.

As illustrated in FIG. 21, the multi-stage determining unit 321 is configured with nodes of a three-level tree structure such as a first-stage complex determinator 321-1, second-stage complex determinators 321-21 and 321-22, and third-stage complex determinators 321-31 to 321-33. In the following, when it is unnecessary to distinguish the complex determinators from one another, the determinators are collectively referred to as a complex determinator 321.

The complex determinator 321-1 includes a face feature quantity extracting unit 341-1 and a determinator 351-1. The complex determinator 321-21 includes a face feature quantity extracting unit 341-21 and a determinator 351-21. The complex determinator 321-22 includes a face feature quantity extracting unit 341-22 and the determinator 321-22. The complex determinator 321-31 includes the face feature quantity extracting unit 341-31 and the determinator 351-31. The complex determinator 321-32 includes the face feature quantity extracting unit 341-32 and the determinator 351-32. The complex determinator 321-33 includes the face feature quantity extracting unit 341-33 and the determinator 351-33. In the following, when it is unnecessary to distinguish the face feature quantity extracting units and the determinators from one another, the face feature quantity extracting units and the determinators are collectively referred to as a face feature quantity extracting unit 341 and a determinator 351.

The face feature quantity extracting unit 341 extracts a feature quantity of a face from the same facial image H. At this time, different feature quantities of the face may be extracted by the respective face feature quantity extracting units 341. For example, the face feature quantity extracting unit 341-1 included in the complex determinator 321-1 may extract edge information as a feature quantity of a face, and the face feature quantity extracting unit 341-31 included in the complex determinator 321-31 may extract brightness information a feature quantity of a face.

In this case, the determinator 351-1, included in the complex determinator 321-1, to which a first age range “0 to 39” and a second age range “40 or more” are assigned executes a determination based on the edge information of the face extracted by the face feature quantity extracting unit 341-1. Since the face of an aged person has many wrinkles, the determinator 351-1 can easily determine which of the first and second age ranges an age of a person having a corresponding face is classified into based on the edge information.

On the other hand, in the determinator 351-31 included in the complex determinator 321-31, to which a first age range “0 to 9” and a second age range “10 to 19” are assigned, faces of all people classified into either of the two age ranges of the determination target are considered to have few wrinkles. Thus, the determinator 351-31 executes a determination based on any other feature quantity such as brightness information rather than edge information as a feature quantity of a face.

By appropriately changing a feature quantity extracted by the face feature quantity extracting unit 341 according to an age range assigned to the determinator 351 as described above, a determination by which a more correct classification result can be obtained is executed.

### [Another Configuration Example of Age Estimating Apparatus]

In the above examples, a feature quantity of a face is extracted from a facial image H detected by a face detecting unit, and an age of a person having a corresponding face is estimated based on the feature quantity of the face. However, a feature quantity used for age estimation is not limited to a feature quantity of a face, and, for example, a feature quantity of clothes may also be used.

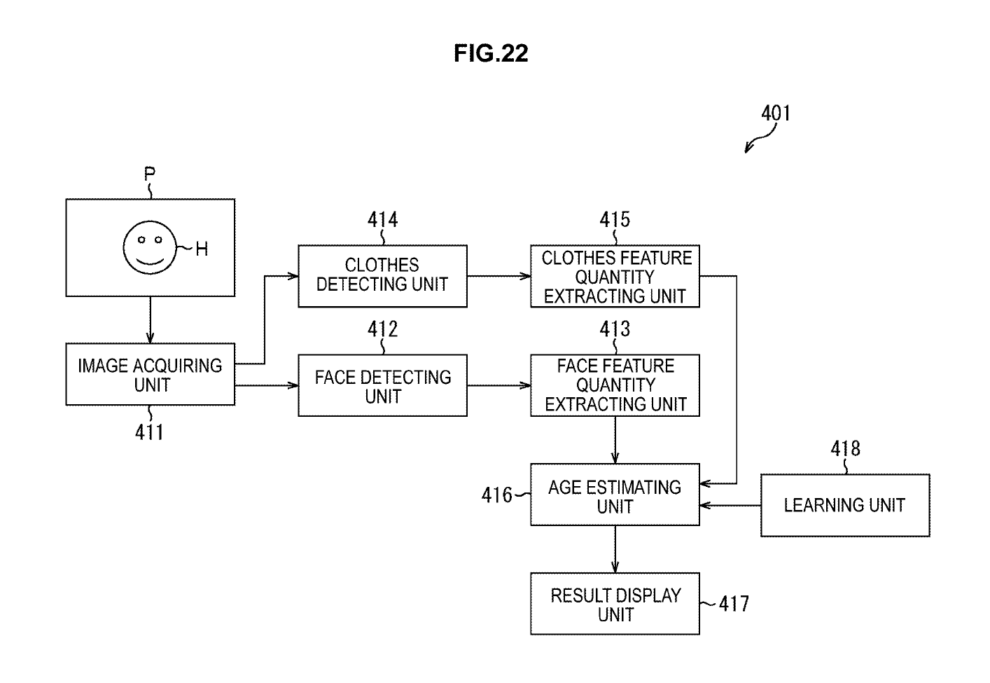

FIG. 22 is a block diagram illustrating a configuration example of an age estimating apparatus 401.

The age estimating apparatus 401 includes an image acquiring unit 411, a face detecting unit 412, a face feature quantity extracting unit 413, a clothes detecting unit 414, a clothes feature quantity extracting unit 415, an age estimating unit 416, a result display unit 417, and a learning unit 418.

The image acquiring unit 411, the face detecting unit 412, the result display unit 417, and the learning unit 418 basically have the same function and configuration as the image acquiring unit 11, the face detecting unit 12, the result display unit 14, and the learning unit 15 of FIG. 1. The face feature quantity extracting unit 413 basically has the same function and configuration as the face feature quantity extracting unit 31 of FIG. 2. Thus, the redundant description thereof will not be repeated.

The clothes detecting unit 414 detects an image of clothes of a person included in an image P acquired by the image acquiring unit 411 from the whole area of the image P.

The clothes feature quantity extracting unit 415 extracts a feature quantity of clothes from the image of the clothes detected by the clothes detecting unit 414.

The age estimating unit 416 estimates an age of a person having a corresponding face and wearing corresponding clothes based on a feature quantity of a face extracted by the face feature quantity extracting unit 413 and the feature quantity of the clothes extracted by the clothes feature quantity extracting unit 415.

Since a feature quantity of a face and another feature quantity are used together for age estimation, a determination by which a more correct classification result can be obtained is executed. Besides the feature quantity of clothes, for example, height, a ratio of head size to height, or the like may be used as another feature quantity. When a feature quantity such as height or the ratio of head size to height is used, a determination by which a more correct classification result can be obtained, particularly on children's age estimation, is executed.

### [Another Example of Estimation Result Integration]

In the above examples, the result integrating unit calculates a reliability degree of an estimation result using an age range span of an age estimation result of each frame Fk estimated by the still image age estimating unit. However, a technique of calculating a reliability degree of an estimation result is not limited to the above example, and, for example, a reliability degree may be calculated by further using the size of a face or a blurring state of the facial image H.

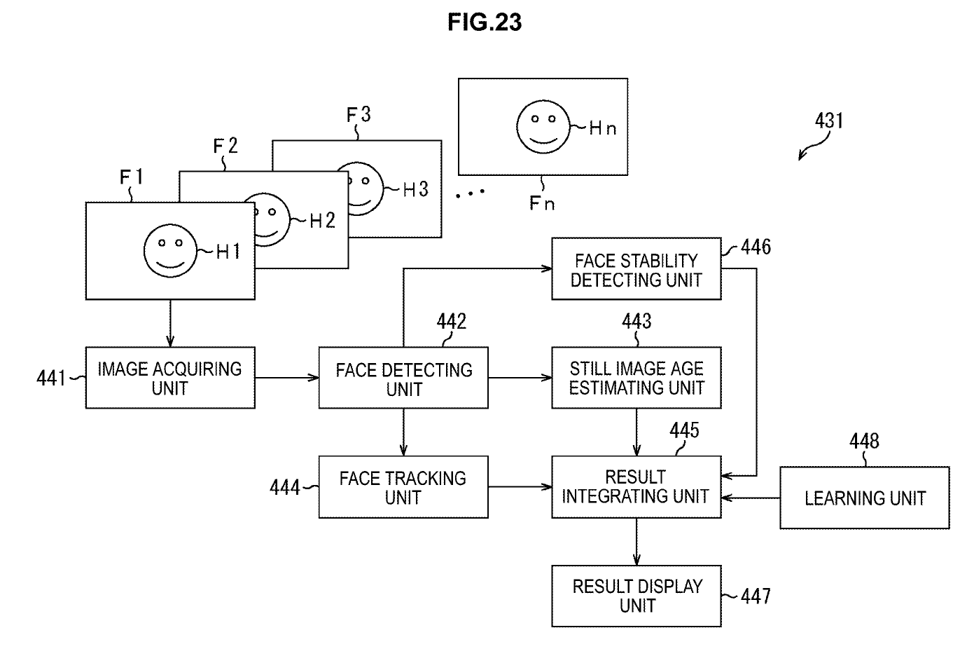

FIG. 23 is a block diagram illustrating a configuration of an age estimating apparatus 431.

The age estimating apparatus 431 includes an image acquiring unit 441, a face detecting unit 442, a still image age estimating unit 443, a face tracking unit 444, a result integrating unit 445, a face stability detecting unit 446, a result display unit 447, and a learning unit 448.

The image acquiring unit 441, the face detecting unit 442, the still image age estimating unit 443, the face tracking unit 444, the result display unit 447, and the learning unit 448 basically have the same function and configuration as the image acquiring unit 161, the face detecting unit 162, the still image age estimating unit 163, the face tracking unit 164, the result integrating unit 165, and the learning unit 167 of FIG. 9. Thus, the redundant description thereof will not be repeated.

The face stability detecting unit 446 detects the size of a face or a blurring state from the facial image H detected by the face detecting unit 442. A technique of detecting a blurring state of a face is not particularly limited, and, for example, the face stability detecting unit 446 may detects a blurring state of a face using a Laplacian result.

The result integrating unit 445 integrates age estimation results of frames Fk which the still image age estimating unit 443 has estimated on a predetermined person specified by the face tracking unit 444, and then outputs an estimation result of the predetermined person in a moving image. In other words, the result integrating unit 445 integrates a plurality of estimation results obtained by the still image age estimating unit 443. The result integrating unit 445 may calculate an estimated age probability distribution on a predetermined person in a moving image together with the estimation result.

Specifically, the result integrating unit 445 calculates a reliability degree of an estimation result obtained by the still image age estimating unit 443 using a detection result obtained by the face stability detecting unit 446 as “reliability degree=10/age range spanxface size/blurring state.”

For example, as the face size detected by the face stability detecting unit 446 increases, the reliability degree of the estimation result by the still image age estimating unit 443 increases. Further, as the blurring state of the face detected by the face stability detecting unit 446 increases, the reliability degree of the estimation result by the still image age estimating unit 443 increases.

By using information other than an age range span of an age estimation result for a calculation of the reliability degree of the estimation result, a more correct reliability degree can be calculated.

In the above examples, the result integrating unit integrates the age estimation results of the frames Fk estimated by the still image age estimating unit. However, a target integrated by the result integrating unit is not limited to this example. The result integrating unit may integrate determination results on a plurality of processing targets including the same determination target by the multi-stage determining unit. For example, when a plurality of books or songs are set as processing targets by the multi-stage determining unit, the determination results may be integrated.

As described above, the multi-stage determining unit is configured with the determinators of the tree structure, and the determination process is performed in the multiple stages while sequentially proceeding from an easy determination process to a difficult determination process. Thus, an erroneous classification can be suppressed. Further, when a finer classification is necessary, since the level of the tree structure can be increased, an extension can be easily made.

### [Application to Program of Present Technology]

A series of processes described above may be performed by hardware or software.

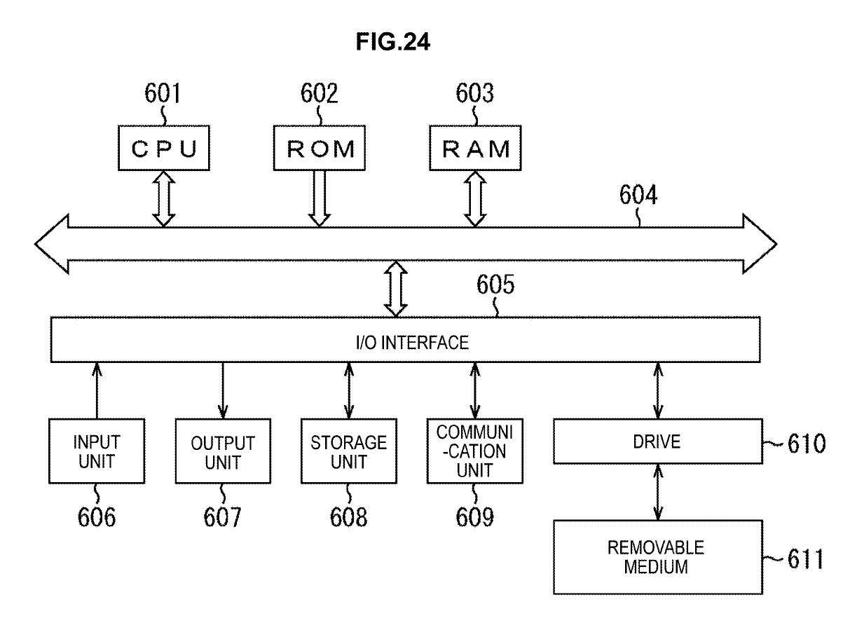

In this case, at least part of the information processing apparatus may employ, for example, a personal computer (PC) illustrated in FIG. 24.

Referring to FIG. 24, a central processing unit (CPU) 601 executes a variety of processes according to a program recorded in a read only memory (ROM) 602. The CPU 601 executes a variety of processes according to a program loaded in a random access memory (RAM) 603 from a storage unit 608. Further, for example, data necessary for the CPU 601 to execute a variety of processes is appropriately stored in the RAM 603.

The CPU 601, the ROM 602, and the RAM 603 are connected to one another via a bus 604. An input/output (I/O) interface 605 is also connected to the bus 604.

An input unit 606 such as a keyboard or a mouse and an output unit 607 such as a display device are connected to the I/O interface 605. Further, the storage unit 608 configured with a hard disk or the like and a communication unit 609 configured with a modem, a terminal adapter, or the like are connected to the I/O interface 605. The communication unit 609 controls communication with another device (not shown) via a network such as the Internet.

Further, a drive 610 is connected to the I/O interface 605 as necessary, and a removable medium 611 including a magnetic disk, an optical disc, a magneto-optical disc, or a semiconductor memory is mounted to the I/O interface 605. A computer program read from the removable medium 611 is installed in the storage unit 608 as necessary.

When a series of processes is performed by software, a program configuring the software is installed in a computer incorporated into dedicated hardware, a general-purpose computer in which various programs can be installed and various functions can be executed, or the like from a network or a recording medium.

A recording medium containing this program may be configured with the removable medium (package medium) 611 which is distributed in order to provide a user with a program separately from a device body as illustrated in FIG. 24 and includes a magnetic disk (including a floppy disk), an optical disc (including a compact disc (CD)-ROM, a digital versatile disc (DVD), or the like), a magneto-optical disc (including a MiniDisc (MD)), a semiconductor memory, or the like, which records a program. Further, the recording medium containing this program may be configured with the ROM 602 in which a program is recorded, a hard disk included in the storage unit 608, or the like, which is provided to the user in a state incorporated in a device body in advance.

Further, in this disclosure, steps describing a program recorded in a recording medium include not only processes which are performed in time series in that order but also processes which are executed in parallel or individually, and not necessarily performed in time series.

The present technology can be applied to an information processing apparatus that classifies data.

Additionally, the present technology may also be configured as below.

(1) An information processing apparatus, comprising:
a multi-stage determining unit that includes determinators which each function as a node of an N-level tree structure (N is an integer value of 2 or more) in order to perform determination for classifying a determination target into at least one of a plurality of ranges,
wherein each determinator performs determination of classifying the determination target into any one of two ranges, and
the two ranges determined in each determinator include an overlapping portion.

(2) The information processing apparatus according to (1),
wherein the multi-stage determining unit further includes a feature quantity extracting unit that extracts a feature quantity related to the determination target from an image including the determination target, and
each determinator performs the determination based on the feature quantity extracted by the feature quantity extracting unit.

(3) The information processing apparatus according to (1) or (2),
wherein a predetermined range from a boundary between the two ranges is set as a dead zone range in advance, and
when a determinator of a predetermined level has classified the determination target into the dead zone range, the multi-stage determining unit prohibits determination of a determinator of a next level and performs final determination based on a determination result of up to the determinator of the predetermined level.

(4) The information processing apparatus according to (1), (2), or (3),
wherein the multi-stage determining unit sets each of a plurality of unit images configuring a moving image as a processing target,
for each processing target, the feature quantity extracting unit extracts a feature quantity, and each determinator performs the determination, and
the information processing apparatus further comprises a result integrating unit that integrates a result of the determination for each processing target by the multi-stage determining unit.

(5) The information processing apparatus according to any one of (1) to (4),
wherein the processing target includes a plurality of processing targets,
the multi-stage determining unit further includes a feature quantity extracting unit that extracts a feature quantity related to the processing target for each of the plurality of processing targets, and
the information processing apparatus further comprises a result integrating unit that integrates a result of the determination for each of the plurality of processing targets by the multi-stage determining unit.

(6) The information processing apparatus according to any one of (1) to (5),
wherein the result integrating unit sets a reliability distribution in each range represented by each result of the determination for each processing target by the multi-stage determining unit, and calculates a probability distribution that the determination target is classified into a predetermined range by adding the reliability distribution of each processing target.

(7) The information processing apparatus according to any one of (1) to (6),
wherein the determination target is a person, and the plurality of ranges related to an age are set in advance,
the feature quantity extracting unit extracts a feature quantity of a face from an image including a person's face, and
each determinator determines an age range of the person having the face and classifies the person's age into any one of the plurality of ranges.

(8) The information processing apparatus according to any one of (1) to (7),
wherein the determination target is a person, and the plurality of ranges related to a race are set in advance,
the feature quantity extracting unit extracts a feature quantity of a face from an image including a person's face, and
each determinator determines a race range of the person having the face and classifies the person's race into any one of the plurality of ranges.

(9) The information processing apparatus according to any one of (1) to (8),
wherein the determination target is a person, and the plurality of ranges related to a facial expression are set in advance,
the feature quantity extracting unit extracts a feature quantity of a face from an image including a person's face, and
each determinator determines a facial expression range of the person having the face and classifies the person's facial expression into any one of the plurality of ranges.

(10) The information processing apparatus according to any one of (1) to (9),
wherein the feature quantity extracting unit extracts a feature quantity related to a person's clothes from the image.

(11) An information processing method, comprising:
preparing determinators which each function as a node of an N-level tree structure (N is an integer value of 2 or more) in order to perform determination for classifying a determination target into at least one of a plurality of ranges; and
performing, with each determinator, determination of classifying the determination target into any one of two ranges,
wherein the two ranges determined in each determinator include an overlapping portion.

(12) A program for causing a computer to execute a control process, the control process comprising:
preparing determinators which each function as a node of an N-level tree structure (N is an integer value of 2 or more) in order to perform determination for classifying a determination target into at least one of a plurality of ranges; and
performing, with each determinator, determination of classifying the determination target into any one of two ranges,
wherein the two ranges determined in each determinator include an overlapping portion.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
a multi-stage determining unit that includes determinators which each function as a node of an N-level tree structure (N is an integer value of 2 or more) in order to perform determination for classifying a determination target into at least one of a plurality of ranges,
wherein each determinator performs determination of classifying the determination target into any one of two ranges, and
the two ranges determined in each determinator include an overlapping portion.

2. The information processing apparatus according to claim 1,
wherein the multi-stage determining unit further includes a feature quantity extracting unit that extracts a feature quantity related to the determination target from an image including the determination target, and
each determinator performs the determination based on the feature quantity extracted by the feature quantity extracting unit.

3. The information processing apparatus according to claim 1,
wherein a predetermined range from a boundary between the two ranges is set as a dead zone range in advance, and
when a determinator of a predetermined level has classified the determination target into the dead zone range, the multi-stage determining unit prohibits determination of a determinator of a next level and performs final determination based on a determination result of up to the determinator of the predetermined level.

4. The information processing apparatus according to claim 2,
wherein the multi-stage determining unit sets each of a plurality of unit images configuring a moving image as a processing target,
for each processing target, the feature quantity extracting unit extracts a feature quantity, and each determinator performs the determination, and
the information processing apparatus further comprises a result integrating unit that integrates a result of the determination for each processing target by the multi-stage determining unit.

5. The information processing apparatus according to claim 1,
wherein the processing target includes a plurality of processing targets,
the multi-stage determining unit further includes a feature quantity extracting unit that extracts a feature quantity related to the processing target for each of the plurality of processing targets, and
the information processing apparatus further comprises a result integrating unit that integrates a result of the determination for each of the plurality of processing targets by the multi-stage determining unit.

6. The information processing apparatus according to claim 4,
wherein the result integrating unit sets a reliability distribution in each range represented by each result of the determination for each processing target by the multi-stage determining unit, and calculates a probability distribution that the determination target is classified into a predetermined range by adding the reliability distribution of each processing target.

7. The information processing apparatus according to claim 3,
wherein the determination target is a person, and the plurality of ranges related to an age are set in advance,
the feature quantity extracting unit extracts a feature quantity of a face from an image including a person's face, and
each determinator determines an age range of the person having the face and classifies the person's age into any one of the plurality of ranges.

8. The information processing apparatus according to claim 3,
wherein the determination target is a person, and the plurality of ranges related to a race are set in advance,
the feature quantity extracting unit extracts a feature quantity of a face from an image including a person's face, and
each determinator determines a race range of the person having the face and classifies the person's race into any one of the plurality of ranges.

9. The information processing apparatus according to claim 3,
wherein the determination target is a person, and the plurality of ranges related to a facial expression are set in advance,
the feature quantity extracting unit extracts a feature quantity of a face from an image including a person's face, and
each determinator determines a facial expression range of the person having the face and classifies the person's facial expression into any one of the plurality of ranges.

10. The information processing apparatus according to claim 3,
wherein the feature quantity extracting unit extracts a feature quantity related to a person's clothes from the image.

11. An information processing method, comprising:
preparing determinators which each function as a node of an N-level tree structure (N is an integer value of 2 or more) in order to perform determination for classifying a determination target into at least one of a plurality of ranges; and
performing, with each determinator, determination of classifying the determination target into any one of two ranges,
wherein the two ranges determined in each determinator include an overlapping portion.

12. A program for causing a computer to execute a control process, the control process comprising:
preparing determinators which each function as a node of an N-level tree structure (N is an integer value of 2 or more) in order to perform determination for classifying a determination target into at least one of a plurality of ranges; and
performing, with each determinator, determination of classifying the determination target into any one of two ranges,
wherein the two ranges determined in each determinator include an overlapping portion.
